(19) United States
(12) Patent Application Publication
(10) Pub. No.: US 2026/0065110 A1
(43) Pub. Date: Mar. 5, 2026

(54) FAULT TOLERANT PREPARATION OF QUANTUM POLAR CODES

(71) Applicants: COMMISSARIAT A L'ENERGIE ATOMIQUE ET AUX ENERGIES ALTERNATIVES, Paris (FR); UNIVERSITÉ GRENOBLE ALPES, Saint-Martin-D'heres (FR); INSTITUT POLYTECHNIQUE DE GRENOBLE, Grenoble Cedex 1 (FR); CENTRE NATIONAL DE LA RECHERCHE SCIENTIFIQUE, Paris (FR)

(72) Inventors: Valentin SAVIN, Grenoble Cedex 09 (FR); Ashutosh-Kumar GOSWAMI, Grenoble Cedex 09 (FR); Mehdi MHALLA, Grenoble (FR)

(73) Assignees: COMMISSARIAT A L'ENERGIE ATOMIQUE ET AUX ENERGIES ALTERNATIVES, Paris (FR); UNIVERSITÉ GRENOBLE ALPES, Saint-Martin-D'heres (FR); INSTITUT POLYTECHNIQUE DE GRENOBLE, Grenoble Cedex 1 (FR); CENTRE NATIONAL DE LA RECHERCHE SCIENTIFIQUE, Paris (FR)

(21) Appl. No.: 19/108,191

(22) PCT Filed: Sep. 7, 2023
(86) PCT No.: PCT/EP2023/074579

§ 371 Date: Mar. 3, 2025

(30) Foreign Application Priority Data
Sep. 7, 2022 (EP) 22306327.2

(51) Int. Cl. G06N 10/20; G06N 10/70

(52) U.S. Cl. CPC G06N 10/20; G06N 10/70

(57) ABSTRACT

A system of fault tolerant preparation of quantum polar code states includes a set of single-qubit Pauli measurement circuits configured to prepare an initial quantum system of N=2ⁿ single-qubit states associated to an initial quantum base and a set of two qubit Pauli measurement circuits configured to recursively prepare a quantum polar code. At each recursive level k=1 to n, a set of 2ⁿ/2^{k} quantum polar code states of codelengths 2^{k} is prepared. Each quantum polar code state is prepared by the application of two-qubit Pauli measurement P⊗P circuits on two equivalent polar code states belonging to the output of the antecedent recursive level k−1 and referenced by two corresponding sets of indices each having first and second sets of frozen indices corresponding to first and second quantum bases respectively. The antecedent of the first recursive level k=1 is the initial quantum system of single-qubit states.

### FIELD OF THE INVENTION

The present invention concerns the field of quantum computation and more particularly of fault tolerant preparation of quantum error correcting code states. It relates more specifically to a system and a method of preparation of quantum polar code states for fault tolerant quantum computation.

### Background of the Invention

Quantum computers make use of quantum phenomena such as superposition and entanglement to perform computation. Through precise control of these phenomena, it is in principle possible for quantum computers to outperform their classical counterparts. Quantum computation is based on the manipulation of quantum bits or “qubits” which can be regarded as a superposition of the 1 and 0 states of a quantum physical variable.

A qubit is the basic unit of quantum information, also called quantum state |ψ [symbol] which corresponds to a superposition of basis states |0 [symbol] and |1 [symbol] , as follows:

$$\vert ψ 〉 = α \vert 0 〉 + β \vert 1 〉 \qquad ( 1 )$$

where α and β are complex numbers satisfying the normalization constraint, |α|²+|β|²=1. The quantum state |ψ [symbol] is a vector in a complex linear vector space, known as the Hilbert space. The set {|0 [symbol] , |1 [symbol] } is an orthogonal basis of the Hilbert state, known as the computational basis. This basis is not unique. For example, another important basis is the phase basis, which corresponds to the set {|+ [symbol] , |− [symbol] }, where |+ [symbol] and |− [symbol] are orthogonal vectors defined as follows:

$$\vert + 〉 := \frac{\vert 0 〉 + \vert 1 〉}{\sqrt{2}} , \vert - 〉 := \frac{\vert 0 〉 - \vert 1 〉}{\sqrt{2}} \qquad ( 2 )$$

A qubit |ψ [symbol] can also be written as a superposition of basis states |+ [symbol] and |− [symbol] . The quantum state or qubit |ψ [symbol] in Eq. (1) can be expressed in the phase basis, as follows:

$$\vert ψ 〉 = \frac{α + β}{\sqrt{2}} \vert + 〉 + \frac{α - β}{\sqrt{2}} \vert - 〉 \qquad ( 3 )$$

The basis states can be extended to N qubits, where N>1, by tensor product. For a binary vector u=(u₁, . . . , u_{N})∈{0, 1}^{N}, let |u [symbol] =|(u₁, . . . , u_{N}) [symbol] :=|u₁ [symbol] ⊗ . . . ⊗ |u_{N} [symbol] . Then, the set {|u [symbol] | u∈{0, 1}^{N}} is the computational basis on N qubits.

Any N qubit quantum state can be written as a superposition of the N qubit computational basis states:

$$\vert ψ 〉 = {\sum }_{u ∈ {\{ 0 , 1 \}}^{N}} {α}_{u} \vert u 〉 , \qquad ( 4 )$$

where αᵤ are complex numbers satisfying the normalization condition Σᵤ|αᵤ|²=1. Similarly, the quantum state |ψ [symbol] can also be written as superposition of N qubit phase basis states, which are tensor products of |+ [symbol] and |− [symbol] states.

A quantum state |ψ [symbol] on N qubits is said to be entangled if it is not possible to write |ψ [symbol] as a tensor product of N single qubit quantum states, that is:

$$\vert ψ 〉 \neq \vert {ψ}_{1} 〉 ⊗ \vert {ψ}_{2} 〉 ⊗ … ⊗ \vert {ψ}_{N} 〉 \qquad ( 5 )$$

where |ψ₁ [symbol] , |ψ₂ [symbol] , . . . , |ψ_{N} [symbol] are single qubit states. Hence, entanglement refers to correlation between parts of a quantum system. It is a peculiar property of quantum systems, as it does not have a classical counterpart.

The processing of quantum information is performed by applying quantum gates on qubits. Some examples of these quantum gates are Pauli, Hadamard, and CNOT gates.

Pauli gates are a set of four quantum gates, denoted by I, X, Y, Z, which act on a single qubit. Their action in the computational basis is as follows:

$$I \vert 0 〉 = \vert 0 〉 , I \vert 1 〉 = \vert 1 〉 \qquad ( 6 )$$

$$X \vert 0 〉 = \vert 1 〉 , X \vert 1 〉 = \vert 0 〉 \qquad ( 7 )$$

$$Z \vert 0 〉 = \vert 0 〉 , Z \vert 1 〉 = - \vert 1 〉 \qquad ( 8 )$$

$$Y \vert 0 〉 = i \vert 1 〉 , Y \vert 1 〉 = - i \vert 0 〉 \qquad ( 9 )$$

Note that Y=iZX, and X²=Y²=Z²=I, where I is the identity operator in Eq. (6). From Eq. (7), Pauli X acts like a NOT gate in the computational basis. From Eq. (8), it also follows that Z|+ [symbol] =|− [symbol] and Z|− [symbol] =|+ [symbol] , hence Pauli Z acts like a NOT gate in the phase basis.

Pauli gates are extended to act on N qubits by tensor product. For example, X⊗Z is a Pauli operator on two qubits.

Let [symbol] _{N} be the set of all Pauli operators on N qubits, and [symbol] _{N}:={±1, ±i}× [symbol] _{N}, the set of Pauli operators possibly with a ±1 or ±i sign. Then [symbol] _{N} is a mathematical group, which is referred to as the N-qubit Pauli group. It is worth noting here that any two elements g₁, g₂∈ [symbol] _{N} either commute, that is, [g₁, g₂]:=g₁g₂−g₂g₁=0, or anti-commute, that is, {g₁, g₂}:=g₁g₂+g₂g₁=0.

The Hadamard gate, denoted by H, acts on a single qubit. It maps a computational basis state to a phase basis state and vice-versa. Its action in the computational basis is as follow:

$$H \vert 0 〉 = \vert + 〉 , H \vert 1 〉 = \vert - 〉 \qquad ( 10 )$$

FIG. 1 represents a Controlled-NOT (CNOT) gate the CNOT_{2→1}. The gate takes as input two qubits with control on the second qubit and target on the first qubit. Each horizontal wire carries a single qubit from left to right. In the computational basis, the action of the gate takes place at the target qubit while the control qubit is unaffected by this action. Precisely, the gate CNOT_{2→1} acts similarly to the classical reversible XOR gate, denoted XOR_{2→1}, in the computational basis, that is:

$${CNOT}_{2 \to 1} ( \vert x 〉 ⊗ \vert y 〉 ) = \vert x ⊕ y 〉 ⊗ \vert y 〉 , x , y ∈ \{ 0 , 1 \} \qquad ( 11 )$$

where x⊕y denotes the XOR (sum modulo 2) of binary values x and y.

The CNOT_{2→1} gate and the classical XOR gate are represented by the same circuit except to the fact that the CNOT gate acts on two qubits, while the XOR gate acts on two bits.

It is worth noting that CNOT_{2→1} acts as the XOR_{1→2} gate (with reversed control and target) in the phase basis. Precisely, let |0̅ [symbol] :=|+ [symbol] and |1̅ [symbol] :=|− [symbol] , then we have the following:

$${CNOT}_{2 \to 1} ( \vert \overline{x} 〉 ⊗ \vert \overline{y} 〉 ) = \vert \overline{x} 〉 ⊗ \vert \overline{x ⊕ y} 〉 , x , y ∈ \{ 0 , 1 \} \qquad ( 12 )$$

FIGS. 2A and 2B represent quantum measurement circuits on a qubit in computational and phases bases. The single wire on the input carries a single qubit while the double wire on the output carries a single classical bit.

In general, a quantum measurement on a qubit is performed with respect to an orthogonal basis, and the measurement outcome gives classical information. After the measurement, the qubit collapses randomly into one of the basis states, depending on the measurement outcome.

In particular, FIG. 2A represents the measurement of the qubit |ψ [symbol] =α|0 [symbol] +β|1 [symbol] in the computational basis. The measurement output is 0 with probability |α|² and 1 with probability |β|². If the measurement outcome is 0, then the output state is |0 [symbol] and if the measurement outcome is 1, then the output state is |1 [symbol] .

The computational basis measurement is also known as the Pauli Z measurement as |0 [symbol] and |1 [symbol] are eigenstates of the Pauli gate Z.

FIG. 2B represents the measurement of the qubit |ψ [symbol] =α|0 [symbol] +β|1 [symbol] in the phase basis {+ [symbol] , |− [symbol] }. The measurement circuit is equivalent to first applying the Hadamard gate on |ψ [symbol] , and then measuring it in the computational basis.

The phase basis measurement is also known as the Pauli X measurement as |+ [symbol] and |− [symbol] are eigenstates of the Pauli gate X.

Although various technologies exist for implementing quantum computers, they all share the same shortcomings, namely that the qubits are affected by external noise and decoherence. Whereas bits in classical computers are materialized at the physical level by on/off states of transistor switches with high error margins, there is no such security for qubits. Indeed, the fragile superposition of states of a qubit may easily be disturbed by its environment and collapse, resulting in a loss of information. Quantum computers therefore fundamentally require error correction codes and fault tolerance at the physical level.

Quantum error correcting codes entangle several physical qubits, which act as a logical qubit. Entanglement between physical qubits is used to protect the logical information from error. More precisely, entanglement defines a correlation between physical qubits in terms of their Pauli operators, and an error happening on physical qubits changes the correlation. It is possible to detect this change in correlation by doing joint quantum measurements, in a way that the logical information is not collapsed. The classical information learned by doing this measurement is called a ‘syndrome’. The extracted syndrome is given as an input to a classical decoder, which generates an estimate of the error that has happened.

There are different types of quantum error correcting codes such as stabilizer codes and Calderbank-Steane-Shor (CSS) codes.

A stabilizer code on N physical qubits is defined using a subgroup [symbol] of the N-qubit Pauli group [symbol] _{N}. The codespace corresponding to the stabilizer code is the subset of the N-qubit Hilbert space, stabilized by the subgroup [symbol] . A Pauli operator g∈ [symbol] _{N} stabilizes a quantum state |φ [symbol] , if it is an eigenstate of g with the eigenvalue 1, that is:

$$g \vert ϕ 〉 = \vert ϕ 〉 \qquad ( 13 )$$

A subset C of quantum states is said to be stabilized by a subgroup [symbol] ⊂ [symbol] _{N} if every element g∈ [symbol] stabilizes every quantum state |φ [symbol] ∈C.

Note that for C to be non-empty, it is sufficient to have −I∉ [symbol] and all the elements in [symbol] commute with each other, meaning that, for any two elements g₁, g₂∈ [symbol] , we have:

$$[ {g}_{1} , {g}_{2} ] = 0 \qquad ( 14 )$$

The subgroup [symbol] can be completely specified by a generating set G={g₁, g₂, . . . , g_{N}}. A generating set is independent if any gᵢ∈G cannot be written as a product of elements from {g₁, g₂, . . . , g_{N}}\{gᵢ}. The size of an independent generating set determines the number of logical qubits encoded by the stabilizer code. Precisely, if the number of elements in an independent generating set is equal to N−K, then the stabilizer code encodes K qubits. When K=0, the code does not encode any quantum information, as it has only one fixed quantum state in its codespace, called a stabilizer state.

Stabilizer codes are suitable for detecting Pauli errors. Consider a code state |ψ [symbol] , on which a random N-qubit Pauli error E∈ [symbol] _{N} happens. Since any two elements of [symbol] _{N} either commute or anti-commute, then, for any gᵢ∈G, we have the following:

$${g}_{i} E \vert ψ 〉 = {( - 1 )}^{a} E \vert ψ 〉 \qquad ( 15 )$$

where α=0 if gᵢ commutes with E, and α=1 if gᵢ anti-commutes with E. Therefore, if gᵢ anti-commutes with E, Eq. (15) implies that the error corrupted state E|ψ [symbol] is an eigenstate of gᵢ, with eigenvalue −1. This means that we can detect the error by doing the Pauli measurement corresponding to the generator gᵢ.

The syndrome measurement of stabilizer codes corresponds to measuring all the generators g₁, g₂, . . . , g_{N}. Based on the extracted syndrome, an estimate Ê of E is then generated using a classical decoder.

The CSS codes are an important subclass of stabilizer codes. A stabilizer code is a CSS code if there exists a generating set G=G_{X}∪G_{Z} of the stabilizer group, such that any gₓ∈G_{X} can be written as a tensor product of I and X, that is, gₓ=X^{u}:=X^{u}^{₁}⊗X^{u}^{₂} ⊗ . . . ⊗X^{u}^{_{N}}, for some u=(u₁, u₂, . . . , u_{N})∈{0, 1}^{N}, and similarly any g_{z}∈G_{Z} can be written as a tensor product of I and Z, that is, g_{z}=Z^{v}:=Z^{v}^{₁}⊗Z^{v}^{₂} ⊗ . . . ⊗ Z^{v}^{_{N}} for some v=(v₁, v₂, . . . , v_{N})∈{0, 1}^{N}. Since, gₓ and g_{z} must commute with each other, this imposes the following constraint:

$$u \cdot v := {\sum }_{i} {u}_{i} {v}_{i} = 0 ( mod 2 ) \qquad ( 16 )$$

The CSS code may be associated with two classical codes on N bits, with parity check matrices H_{X} and H_{Z}, where H_{X} is a binary matrix whose rows are vectors u∈{0, 1}^{N} such that X^{u}∈G_{X}, and H_{Z} is a binary matrix whose rows are vectors v∈{0, 1}^{N}, such that Z^{v}∈G_{Z}. Then, Eq. (13) is equivalent to:

$${H}_{X} {H}_{Z}^{T} = 0 ( mod 2 ) \qquad ( 17 )$$

Similarly, CSS quantum polar codes are constructed on the basis of classical polar codes.

FIGS. 3A and 3B represent the encoding of classical polar codes using reversible XOR gates.

The encoding of classical polar codes is done by applying the reversible XOR gate recursively on an N-bit input u=(u₁, u₂, . . . , u_{N})∈{0, 1}^{N}, where N=2ⁿ, n>0. For a set of positions [symbol] ={1, . . . , N−1}, the corresponding component u [symbol] ∈ [symbol] of the input vector u is frozen (i.e. fixed). We may take [symbol] to be any vector in [symbol] , but it should be known to both the encoder and decoder. The set [symbol] is called the ‘frozen set’. The remaining positions [symbol] :={1, . . . , N−1}\ [symbol] are used to encode bits. The set [symbol] is called the ‘information set’.

In the following, we denote by P(N, [symbol] , [symbol] ), the classical polar code of codelength N, frozen positions [symbol] , and frozen vector [symbol] ∈ [symbol] .

The action of the reversible XOR gate XOR_{2→1} on u=(u₁, u₂)∈{0, 1}² gives u′=(u₁⊕u₂, u₂). The vector u′ can be expressed as u′=P₂u, where P₂ is the following matrix:

$${P}_{2} = [ \begin{matrix}1 & 1 \\ 0 & 1\end{matrix} ] \qquad ( 18 )$$

Classical polar transform, that is, the recursive application of XOR_{2→1} on N=2ⁿ qubits, is given by the matrix

$${P}_{N} = {P}_{2}^{⊗ n} .$$

We note that the action of the opposite XOR, i.e., XOR_{1→2} is described by

$${P}_{2}^{T} ,$$

i.e. the transpose of P₂. Hence, the recursive application of XOR_{1→2} is described by

$${P}_{N}^{T} .$$

For any vector of information bits [symbol] ∈ [symbol] , y=P_{N}( [symbol] , [symbol] )∈{0, 1}^{N} is a codeword of the polar code P(N, [symbol] , [symbol] ). Let

$${P}_{N}^{( j )}$$

be the jth column of P_{N}, for j∈{1, . . . , N−1} and let [symbol] be the all zero vector. Then, the classical polar code P (N, [symbol] , [symbol] ) is generated by the set

$$G = \{ {P}_{N}^{( j )} \vert j ∈ 𝒥 \} .$$

Classical polar codes have an efficient decoder known as ‘successive cancellation’ (SC) decoder. SC decoder takes as input the frozen vector u [symbol] , and a noisy version of the codeword y⊕e, where y=P_{N}( [symbol] , [symbol] ) is a codeword, and e∈{0, 1} Nis a random error, and it outputs an estimate [symbol] of [symbol] .

The polar transform P_{N}, for any N=2ⁿ, n≥0, relates to

$${P}_{\frac{N}{2}} ,$$

as depicted in FIG. 3A. Similarly,

$${P}_{\frac{N}{2}}$$

relates to

$${P}_{\frac{N}{4}} , and {P}_{\frac{N}{4}}$$

relates to

$${P}_{\frac{N}{8}}$$

and so on. Hence, doing this recursively, we can express P_{N} only in terms of the XOR gate.

FIG. 3B represents the polar transform of a classical polar code of codelength N=2³ encoding 5 bits and where 3 bits are frozen. In this example, the frozen set is [symbol] ={1,2,3} and the frozen vector is [symbol] =(0,0,0).

In what follows, we use the notation |0̅ [symbol] :=|+ [symbol] and |1̅ [symbol] :=|− [symbol] to denote phase basis states. For u=(u₁, . . . , u_{N})∈{0, 1}^{N}, we define |ū [symbol] =|u̅₁̅ [symbol] ⊗|u̅₂̅ [symbol] ⊗ . . . ⊗|u̅_̅{̅N̅}̅ [symbol] . Moreover, we define X^{u}:=X^{u}^{₁}≤X^{u}^{₂} ⊗ . . . ⊗ X^{u}^{_{N}}, and similarly Z^{u}:=Z^{u}^{₁} ⊗Z^{u}^{₂} ⊗ . . . ⊗ Z^{u}^{_{N}}.

FIG. 4 represents the encoding of CSS quantum polar codes using the quantum CNOT gates.

The encoding of CSS quantum polar codes is done by applying the quantum CNOT gate recursively on an N qubit quantum state |φ [symbol] [symbol] , where [symbol] :={1, . . . , N}. For a subset of positions [symbol] ⊂ [symbol] , the input quantum state is frozen to a computational basis quantum state [symbol] , where u∈ [symbol] , and for another subset [symbol] ⊂ [symbol] , it is frozen to a phase basis state [symbol] , where V∈ [symbol] . For u and v, we may take any vectors in [symbol] and [symbol] , respectively, but they should be known to both the encoder and decoder.

The remaining subset [symbol] := [symbol] \( [symbol] ) is used to encode a quantum state [symbol] . Hence, the uncoded quantum state [symbol] can be written as:

$${{{{\vert ϕ 〉}_{𝒮} = \vert ψ 〉}_{𝒟} ⊗ \vert u 〉}_{𝒵} ⊗ \vert \overline{v} 〉}_{𝒳} \qquad ( 19 )$$

where [symbol] is an arbitrary quantum state that we want to encode. Then, the encoded quantum state is given by [symbol] , where Q_{N} denotes the quantum polar transform on N qubits, that is, the quantum operator on N qubits defined by the recursive application of the CNOT gate.

A quantum polar code on N qubits, with frozen indices [symbol] and [symbol] corresponding to the computational and phase bases, respectively, and with frozen quantum states [symbol] and [symbol] is denoted by Q(N, [symbol] , [symbol] , [symbol] , [symbol] . In particular, the circuit represented in FIG. 4 concerns a quantum polar code Q(N, [symbol] , [symbol] , [symbol] , [symbol] , with N=2³, [symbol] ={1,2,3}, [symbol] ={6,7,8}, [symbol] =|0,0,0), and [symbol] =|0̅,̅0̅,̅0̅ [symbol] .

It is known that CNOT_{2→1} acts as the reversible XOR gate XOR_{2→1} in the computational basis, while it acts as XOR_{1→2} in the phase basis. Hence, the quantum polar transform Q_{N} acts as classical polar transform in the computational basis, while it acts as the opposite polar transform in the phase basis. The polar transform and the opposite polar transform are described by the matrices P_{N} and

$${P}_{N}^{T} ,$$

respectively. Hence, for computational and phase basis states corresponding to u∈{0,1}^{N}, the encoded quantum state [symbol] can be expressed as:

$$= \qquad ( 20 )$$

$$= \qquad ( 21 )$$

To define the X and Z type stabilizer generators of the polar code Q(N, [symbol] , [symbol] , [symbol] , [symbol] ), let

$${e}_{N}^{i}$$

∈{0, 1}^{N} be the binary vector, with 0 everywhere except 1 at the ith position. Hence, the uncoded quantum state [symbol] in Eq. (19) is stabilized by the following Pauli operators:

$$\begin{matrix}{( - 1 )}^{{u}_{i}} {Z}^{{e}_{N}^{i}} , & ∀ i ∈ 𝒵\end{matrix} \qquad ( 22 )$$

$$\begin{matrix}{( - 1 )}^{{v}_{i}} {X}^{{e}_{N}^{i}} , & ∀ i ∈ 𝒳\end{matrix} \qquad ( 23 )$$

Then, it follows that the encoded quantum state [symbol] is stabilized by the following operators:

$$\begin{matrix}{( - 1 )}^{{u}_{i}} {Q}_{N} {Z}^{{e}_{N}^{i}} {Q}_{N} , & ∀ i ∈ 𝒵\end{matrix} \qquad ( 24 )$$

$$\begin{matrix}{( - 1 )}^{{v}_{i}} {Q}_{N} {X}^{{e}_{N}^{i}} {Q}_{N} , & ∀ i ∈ 𝒳\end{matrix} \qquad ( 25 )$$

The above operators are generators of the stabilizer group of the code Q(N, [symbol] , [symbol] , [symbol] , [symbol] ).

The sandwiching actions of the CNOT gate CNOT_{2→1} on two qubit Pauli Z and X type operators are expressed as follows:

$$\begin{matrix}{CNOT}_{2 \to 1} {Z}^{u} {CNOT}_{2 \to 1} = {Z}^{{P}_{2}^{T} u} , & u ∈ {\{ 0 , 1 \}}^{2}\end{matrix} \qquad ( 26 )$$

$$\begin{matrix}{CNOT}_{2 \to 1} {X}^{u} {CNOT}_{2 \to 1} = {X}^{{P}_{2} u} , & u ∈ {\{ 0 , 1 \}}^{2}\end{matrix} \qquad ( 27 )$$

Since Q_{N} is simply the recursion of CNOT_{2→1}, the sandwiching action of Q_{N} is described by classical polar transforms

$${P}_{N}^{T}$$

and P_{N}, respectively, on Z and X type operators. This means that the X and Z type generators of Q(N, [symbol] , [symbol] , [symbol] , [symbol] ) in Eqs. (24) and (25) can be written as follows:

$$\begin{matrix}{( - 1 )}^{{u}_{i}} {Z}^{{P}_{N}^{T} {e}_{N}^{i}} , & i ∈ 𝒵\end{matrix} \qquad ( 28 )$$

$$\begin{matrix}{( - 1 )}^{{v}_{i}} {X}^{{P}_{N} {e}_{N}^{i}} , & i ∈ 𝒳\end{matrix} \qquad ( 29 )$$

Therefore, the Z type stabilizers of the quantum polar code Q(N, [symbol] , [symbol] , [symbol] , [symbol] ) are given by the columns of

$${P}_{N}^{T}$$

corresponding to the set [symbol] , and the X type stabilizers are given by the columns of P_{N}, corresponding to the set [symbol] .

Note from Eqs. (28) and (29) that the vectors u, v cause only a sign factor in the stabilizer generators. Hence, two quantum polar codes that are defined by the same frozen set [symbol] (respectively, [symbol] ), but by different frozen states [symbol] (respectively, [symbol] ) have the same Z (respectively, X) type generating set, up to a sign factor. For this reason, two stabilizer codes having the same sets [symbol] , [symbol] , are said to be ‘equivalent stabilizer codes’.

A quantum polar code Q(N, [symbol] , [symbol] , [symbol] , [symbol] ) as defined above can be used to encode information. However, the preparation of a polar code state according to the implementation of the quantum polar transform as described in relation to FIG. 4 is not fault tolerant, under the effect of noise. In fact, an error caused by a noise on a qubit may propagate to many qubits through the CNOT gates, applied during the implementation. Therefore, the implementation of the quantum polar transform according to the prior art cannot be used for fault tolerant quantum computations.

An object of the present invention is to remedy the aforementioned drawbacks by proposing a circuit for preparing quantum polar code states in a simple manner that can be efficiently used for fault tolerant quantum computations.

### BRIEF DESCRIPTION OF THE INVENTION

The present invention concerns a method of preparation of quantum polar code states in a quantum computing system materializing qubits, quantum gates and quantum circuits, for fault tolerant quantum computation, comprising the following steps:
prepare an initial quantum system [symbol] ={1, . . . , N}, of N=2ⁿ single-qubit states associated to an initial quantum base,
prepare a desired quantum polar code state [symbol] of codelength N=2ⁿ, referenced by predetermined first and second sets of frozen indices [symbol] ={1, . . . , i}, [symbol] ={i+1, . . . , N} with respect to first and second quantum bases respectively, said quantum polar code state [symbol] being prepared by recursively using two qubit Pauli measurement P⊗P circuits wherein, at each recursive level k, where k=1 to n, prepare a set of 2ⁿ/2^{k} quantum polar code states { [symbol] , j(k)=1 to 2ⁿ/2^{k}} of codelengths 2^{k}, referenced by corresponding sets [symbol] of indices comprising first and second sets of frozen indices [symbol] ={1ⱼ, . . . , iⱼ₍ₖ)} and

$${𝒳}_{j ( k )} = \{ {( i + 1 )}_{j ( k )} , … , {2}_{j ( k )}^{k} \} ,$$

each quantum polar code state [symbol] being prepared by applying two qubit Pauli measurement P⊗P circuits on two equivalent polar code states

$$\vert {q}_{{2}^{k - 1}}^{1} {( k - 1 )}_{} and \vert {q}_{{2}^{k - 1}}^{2} {( k - 1 )}_{}$$

belonging to the output of the antecedent recursive level k−1 and referenced by two corresponding sets of indices

$${j ( k - 1 )}_{1}^{} and {j ( k - 1 )}_{2}^{}$$

each of which comprising first and second sets of frozen indices [symbol] and [symbol] corresponding to first and second quantum bases respectively, the antecedent of the first recursive level k=1 being said initial quantum system of single qubit states.

The method according to the present invention enables to prepare in a simple and robust manner, polar code states that can be used in a noiseless scenario as well as in a noisy scenario. According to the present method of preparation of quantum polar code states, any eventual error on a quantum state at any recursive level do not propagate to an increased number of qubits.

Various preferred embodiments of the present invention are defined in the appended claims. In particular, the fault tolerance under the effect of noise is achieved using two different estimation techniques. The first one is based on an error detection technique and the second is based on an error correction technique. The fault tolerant quantum polar code states are important to quantum computation.

### BRIEF DESCRIPTION OF THE DRAWINGS

The present invention will be better understood from the description of the following embodiments, by way of illustration and in no way limitative thereto:

FIG. 1, already described, represents a Controlled-NOT gate the CNOT_{2→1} known from the prior art;

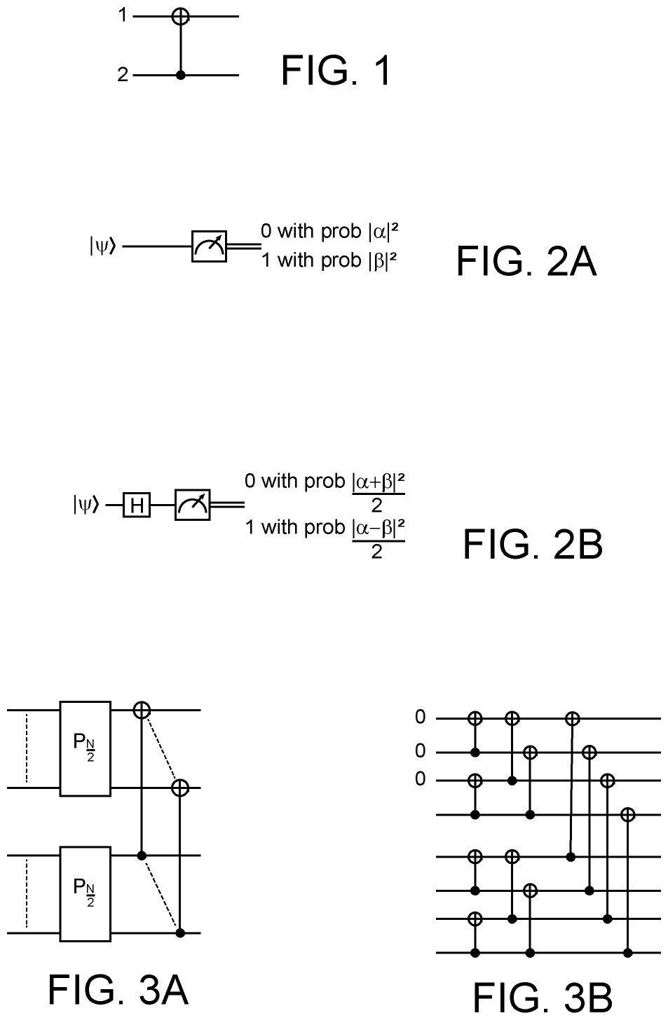

FIGS. 2A and 2B, already described, represent quantum measurement circuits on a qubit in computational and phases bases, known from the prior art;

FIGS. 3A and 3B, already described, represent the encoding of classical polar codes using reversible XOR gates, known from the prior art;

FIG. 4, already described, represents the encoding of CSS quantum polar codes using the quantum CNOT gates, known from the prior art;

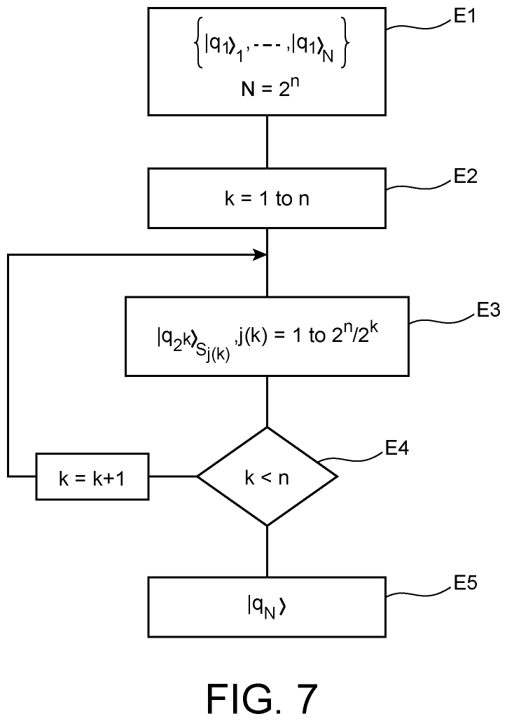

FIG. 5 schematically represents a quantum computing system for the preparation of quantum polar code states, according to a preferred embodiment of the present invention;

FIGS. 6A and 6B schematically represent Pauli Z⊗Z and X⊗X measurement circuits on two qubits D₁ and D₂, used in FIG. 5;

FIG. 7 schematically represents a method of preparation of quantum polar code states according to a preferred embodiment of the present invention;

FIGS. 8A and 8B, schematically represent the preparation of polar code states of length N, given two equivalent polar code states of length N/2, according to an embodiment of the present invention;

FIGS. 9A, 9B, 9C and 9D schematically represent different examples of fault tolerant preparation of quantum polar code states, according to an embodiment of the present invention; and

FIG. 10 schematically represents a computing system according to an embodiment of the present invention.

### DETAILED DISCLOSURE OF PARTICULAR EMBODIMENTS

The present invention proposes a measurement-based preparation of fault tolerant quantum polar code states, using only two qubit quantum measurements.

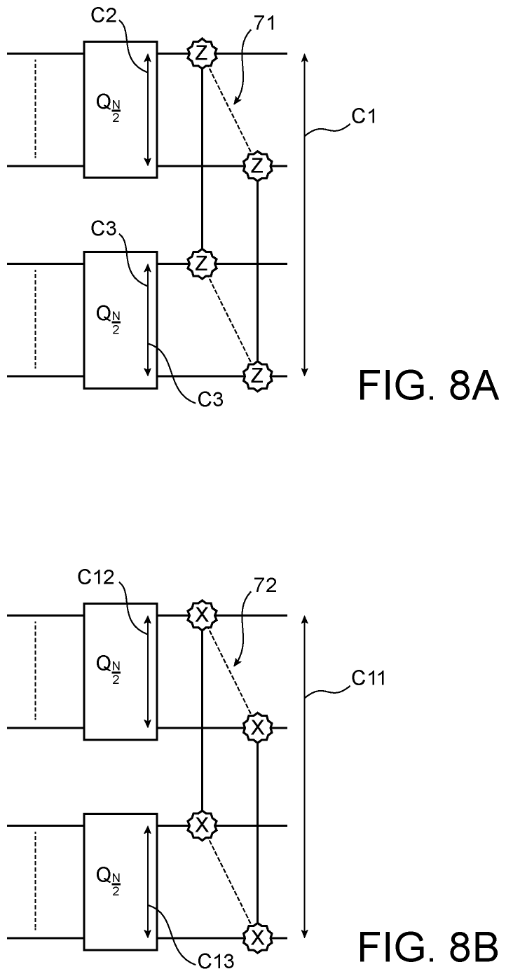

FIG. 5 schematically represents a quantum computing system for the preparation of quantum polar code states to be used for fault tolerant computation, according to a preferred embodiment of the present invention.

The quantum computing system 1 comprises different types of quantum gates 3 that are interconnected by wires 5 to form quantum circuits 7 and in particular, Pauli measurement circuits. The wires 5 carry qubits around the circuits, while the quantum gates 3 execute some operations on the qubits to make quantum computations.

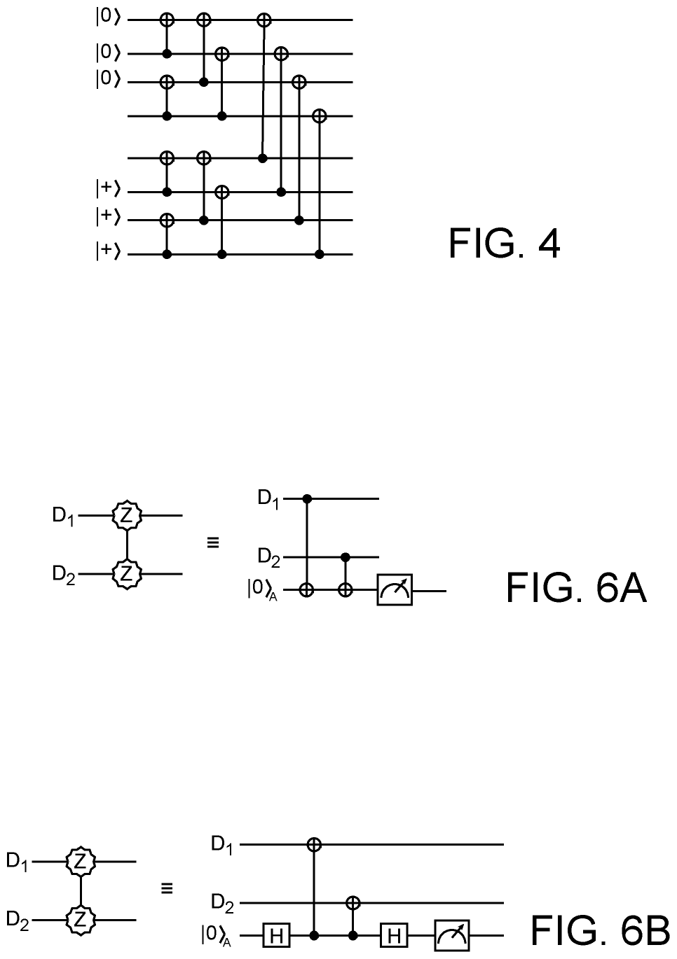

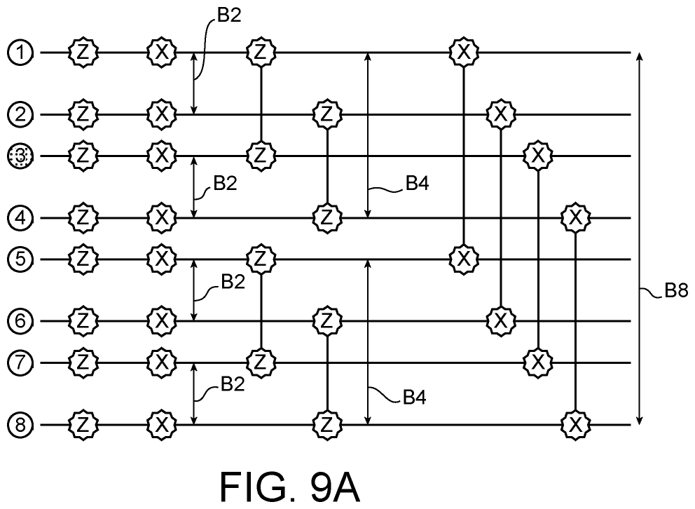

This quantum computing system uses single Pauli measurement circuits for example of the Z and X types (see FIGS. 2A and 2B) as well as two qubit Pauli P⊗P measurement circuits for example of the Z⊗Z type or X⊗X type (see FIGS. 6A and 6B).

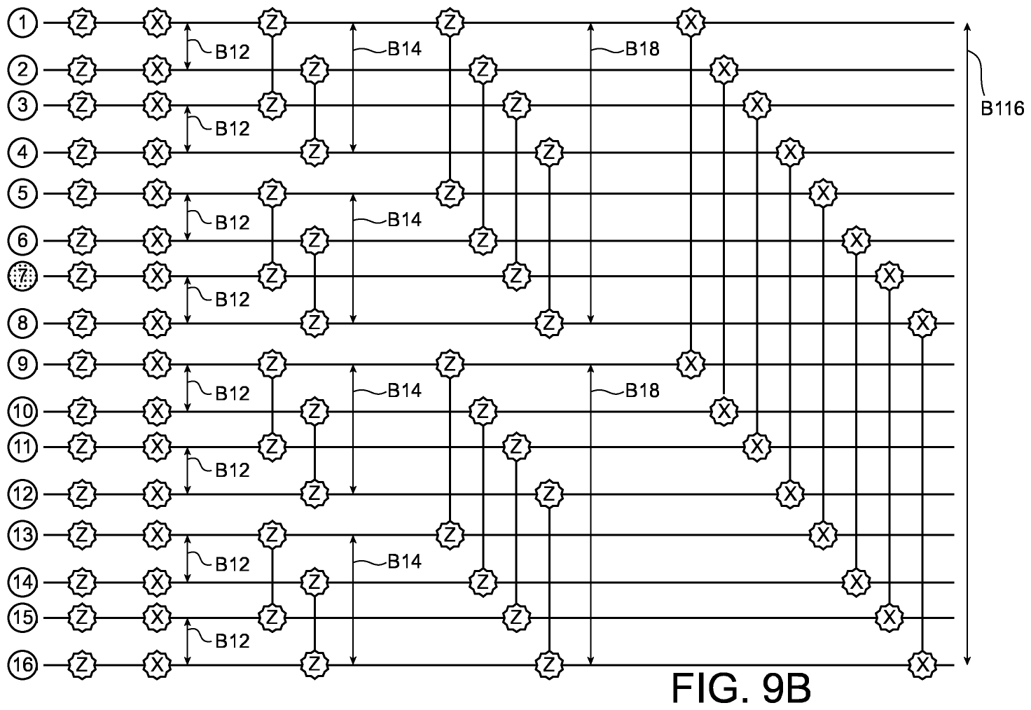

As explained below in relation to FIG. 7, single-qubit measurements are used at an initialization step k=0, as a way to prepare an initial quantum system of N=2ⁿ single-qubit states associated to an initial quantum base. Two-qubit measurements are used at each subsequent step k=1 to n, as a way to prepare a set of quantum polar code states, of codelength 2^{k}.

FIGS. 6A and 6B schematically represent Pauli Z⊗Z and X⊗X measurement circuits on two qubits D₁ and D₂.

In FIG. 6A the right-hand side is a quantum circuit used to implement the Pauli Z⊗Z measurement on two qubits D₁ and D₂ and the left-hand side is simply a shorthand notation for the circuit on the right-hand side.

In practice, Pauli Z⊗Z measurement may be implemented by the circuit on the right hand side, using an ancilla qubit A. Here, qubits D₁ and D₂ are first entangled with A, by applying the CNOT gates CNOT_{D}_{₁}_{→A} and CNOT_{D}_{₂}_{→A}. Then, a Pauli-Z measurement is done on A. The resulting procedure is a Pauli Z⊗Z measurement on qubits D₁ and D₂.

In FIG. 6B the left-hand side is a shorthand notation for the circuit on the right-hand side which is used to implement the Pauli X⊗X measurement on two qubits D₁ and D₂.

In practice, Pauli X⊗X measurement may be implemented by the circuit on the right hand side, using an ancilla qubit A. At first, a Hadamard gate is applied on A. Then it is entangled with qubits D₁ and D₂, by applying the CNOT gates CNOT_{A→D}_{₁}, and CNOT_{A→D}_{₂}. Then another Hadamard gate is applied back on A, which is then followed by a Pauli-Z measurement. The resulting procedure is a Pauli X⊗X measurement on qubits D₁ and D₂.

Various technologies exist for materializing or implementing qubits, quantum gates, quantum circuits and quantum computers. One technology is based on the energy levels of ions trapped in an electric or magnetic field at a temperature near absolute zero using also laser pulses, optical pumping, etc. Another technology may use nuclear magnetic resonance where transformations may be constructed from magnetic field pulses applied to spins in a strong magnetic field, etc. Other technologies use physical systems based on small semiconductors called quantum dots bounding the spin of electrons. Other systems may take advantage of electrons or ions trapped in synthetic diamonds.

Different examples of physical systems materializing qubits, quantum gates and quantum circuits can be found in the reference book entitled “Quantum computation and quantum information” authored by M. A. Nielsen and I. L. Chuang, Cambridge University Press, 2016.

The quantum circuits according to the present invention, comprise different sets of Pauli measurement circuits configured to recursively prepare a fault tolerant quantum polar code [symbol] of codelength N=2ⁿ, where [symbol] ={1, . . . , N} denotes a system of N qubits. These sets are organized in a sequential order of different levels adapted to recursively prepare a quantum polar code [symbol] of codelength N=2ⁿ.

At the first level k=0, a set of single qubit Pauli measurement circuits 3 are used to prepare an initial quantum system of N=2ⁿ single-qubit states, where each qubit is prepared in an initial quantum base. For example, each qubit is prepared as a |0 [symbol] in a Z-quantum-basis.

At each subsequent level k, a set of two qubit Pauli measurement P⊗P circuits are used to prepare a set of quantum polar code states, of codelength 2^{k}, k=1 to n. Lastly, at the final level, the quantum polar code [symbol] of codelength N=2ⁿ is prepared. The details of this preparation is explained in relation to the method of FIG. 7.

FIG. 7 schematically represents a method of preparation of quantum polar code states according to a preferred embodiment of the present invention.

Step E1 concerns the preparation of an initial quantum system [symbol] of N=2ⁿ single-qubit states {|q₁ [symbol] ₁, . . . , |q₁ [symbol] _{N}} associated to an initial quantum base. The initial quantum base may for example, be a computational base |u [symbol] where u∈{0,1}^{N} or a phase base |v̅ [symbol] where v∈{0,1}^{N}.

The initial quantum system of N single-qubit states may be prepared by applying a single qubit Pauli Z measurement circuit on each qubit of an N qubit quantum state.

Steps E2-E5 describe a recursive preparation of a desired quantum polar code [symbol] by using two qubit Pauli measurement P⊗P circuits. The quantum polar code [symbol] is referenced by predetermined first and second sets of frozen indices [symbol] and [symbol] with respect to computational and phase bases, with corresponding frozen values [symbol] and [symbol] .

As an embodiment of the present invention, CSS polar codes Q(N, [symbol] , [symbol] , [symbol] , [symbol] ) that encodes only one information qubit, that is, [ [symbol] ]+| [symbol] |=N−1, are considered. Such a code is constructed as follows. An index i∈ [symbol] :={1, . . . , N} is selected to place the information qubit. All the indices before it belong to the frozen set [symbol] , that is, [symbol] ={1, . . . , i−1}, and all the indices after it belong to the frozen set [symbol] , that is, [symbol] =={i+1, . . . , N}.

The present invention is mainly interested in preparing a logical code state, and therefore, the information qubit corresponding to the selected index i∈ [symbol] may be fixed in either one of the bases. The present invention does not depend on which basis the information qubit is fixed. For example, it may be chosen to fix the information index i∈ [symbol] in the computational basis, i.e., the information qubit may be either |0 [symbol] or |1 [symbol] . In this case, it may be assumed that i∈ [symbol] , meaning that, | [symbol] |+| [symbol] |=N. Thus, according to this example, the indices in the set [symbol] ={1, . . . , i−1, i} are frozen in some computational basis state [symbol] , u∈{0, 1}ⁱ, and the indices [symbol] :={+1, . . . , N} are frozen in some phase basis state [symbol] , v∈{0, 1}^{N-i}. In other words, the desired quantum polar code [symbol] to be prepared may be defined as follows:

$${\vert {q}_{N} = \vert {q}_{{2}^{n}} := {Q}_{N} \vert u , \overline{v} = {Q}_{N} ( \vert u 〉}_{𝒵} ⊗ \vert \overline{v} {〉}_{𝒳} ) \qquad ( 30 )$$

where u∈{0,1}ⁱ and v∈{0,1}^{N-i} are known.

It is to be noted that according to Eqs. (28) and (29) described in the background section, the quantum state [symbol] given in Eq. (30), is a stabilizer state, whose Z and X type stabilizer groups are given by:

$${𝒢}_{Z} := \{ {( - 1 )}^{z \cdot u} {Z}^{{P}_{N}^{T} ( z , 0 )} \vert z ∈ {\{ 0 , 1 \}}^{i} \} \qquad ( 31 )$$

$${𝒢}_{X} := \{ {( - 1 )}^{x \cdot v} {X}^{{P}_{N} ( 0 , x )} \vert x ∈ {\{ 0 , 1 \}}^{N - i} \} \qquad ( 32 )$$

The above Eqs. (31) and (32) imply that any two polar code states, [symbol] and [symbol] defined by the same frozen sets [symbol] , [symbol] ⊂ [symbol] ={1, . . . , N}, have the same stabilizer groups [symbol] and [symbol] , modulo a sign factor even though their corresponding states ( [symbol] , [symbol] ) and ( [symbol] , [symbol] ) may be different. Hence,

$$\vert {q}_{N}^{1} and \vert {q}_{N}^{2}$$

are equivalent as stabilizer states.

Step E2 is a loop counter indexed by an integer k, that controls the recursive levels of a loop from k=1 to k=n. The output of step E1, that is, the initial quantum system of single-qubit states {|q₁ [symbol] ₁, . . . , q₁ [symbol] _{N}} may be considered as a preliminary level k=0. At each recursive level k, a set of 2ⁿ/2^{k} equivalent quantum polar code states { [symbol] , j(k)=1 to 2ⁿ/2^{k}} of codelengths K=2^{k} are prepared.

In particular, step E3 concerns the preparation at the recursive level k, of a set of N/K=2ⁿ/2^{k} quantum polar code states { [symbol] , j(k)=1 to N/K} of codelengths K=2^{k}. This set of N/K quantum polar code states is referenced by corresponding sets [symbol] of indices comprising first and second sets of frozen indices [symbol] ={1ⱼ₍ₖ₎, . . . , iⱼ₍ₖ₎} and

$${𝒳}_{j ( k )} = \{ {( i + 1 )}_{j ( k )} , … , {2}_{j ( k )}^{k} \} .$$

The indices iⱼ₍ₖ₎ are specified for k=1 to n, as follows:

For the last recursion level, k=n, the corresponding index iⱼ₍ₙ)=i, where i∈ [symbol] ={1, . . . , N} is the selected information index used to encode quantum information, hence [symbol] = [symbol] and [symbol] = [symbol] from Eq. (30).

For k<n, the value of iⱼ₍ₖ₎∈{1, . . . , K=2^{k}} is determined from that of iⱼ₍ₖ₊₁₎∈{1, . . . , 2K=2^{k+1}}, according to the following rule:

$$\{ \begin{matrix}{i}_{j ( k )} = {i}_{j ( k + 1 )} - K , & if {i}_{j ( k + 1 )} > K \\ {i}_{j ( k )} = {i}_{j ( k + 1 )} , & otherwise\end{matrix} \qquad ( 33 )$$

Hence, [symbol] ={1ⱼ₍ₖ₎, . . . , iⱼ₍ₖ₎} is the set of the first iⱼ₍ₖ₎ indices of the set [symbol] , while

$${X}_{j ( k )} = \{ {( i + 1 )}_{j ( k )} , … , {2}_{j ( k )}^{k} \}$$

is the set of the last 2^{k}−iⱼ₍ₖ₎ indices of the set [symbol] .

At the recursive level k, each quantum polar code state [symbol] (i.e. [symbol] ) is prepared by applying two qubit Pauli measurement P⊗P circuits on two equivalent polar code states

$$\vert {q}_{K / 2}^{1} {j ( k - 1 )}_{1}^{} and \vert {q}_{K / 2}^{2} {j ( k - 1 )}_{2}^{} ( i . e . , \vert {q}_{{2}^{k - 1}}^{1} {j ( k - 1 )}_{1}^{} and \vert {q}_{{2}^{k - 1}}^{2} {j ( k - 1 )}_{2}^{} )$$

belonging to the output of the antecedent recursive level k−1 and referenced by two corresponding sets of indices [symbol] and [symbol] . Each set of indices comprises first and second sets of frozen indices [symbol] and [symbol] corresponding to the first and second quantum bases respectively, which for example, are the computational and phase bases states respectively. The type of the two-qubit Pauli measurement P⊗P circuits applied on the two equivalent polar code states

$$\vert {q}_{K / 2}^{1} {j ( k - 1 )}_{1}^{} and \vert {q}_{K / 2}^{2} {j ( k - 1 )}_{2}^{}$$

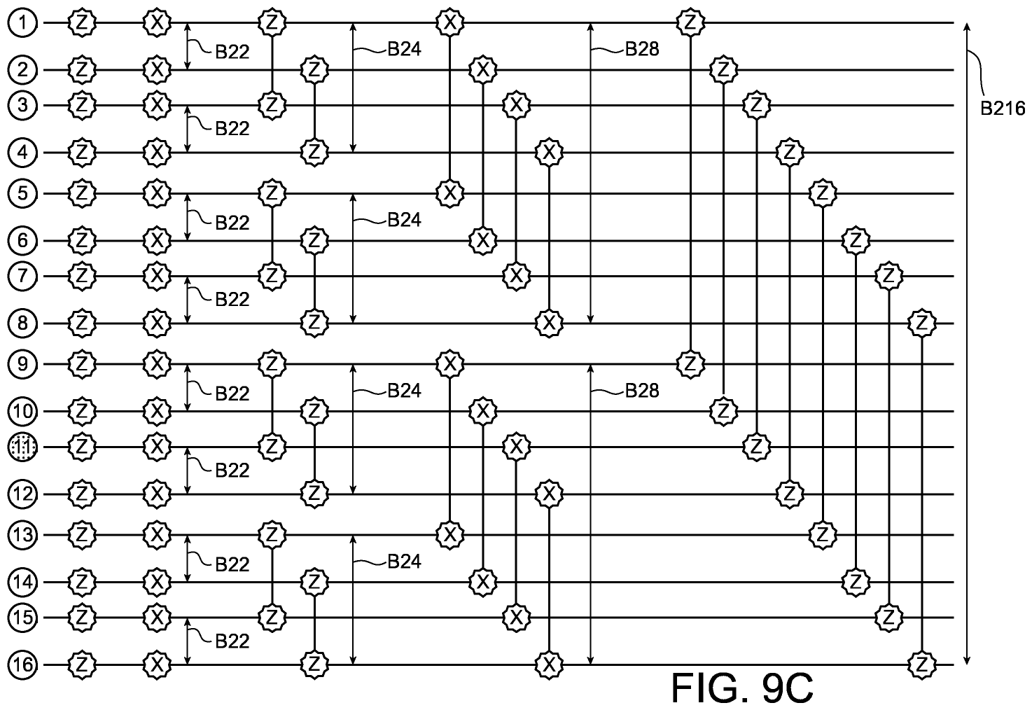

depends on the last index of the first set of frozen indices [symbol] , as described below in relation to FIGS. 8A and 8B.

Step E4 is a test, such that as long as k<n, the loop counter is incremented k=k+1 before looping back to step E3. Otherwise, i.e., when k=n, we go to step E5.

At step E5, we have the desired quantum polar code [symbol] of codelength N=2ⁿ.

The above method shows how to prepare polar code states of length K, given two equivalent polar code states of length K/2, and so on. For K=1, the method is initialized by for example, preparing all the qubits in the computational basis, which can be done for instance by performing single qubit Pauli-Z measurements. Hence, applied recursively, the method is adapted to prepare polar code states of any length K.

FIGS. 8A and 8B, schematically represent the preparation of polar code states of length N, given two equivalent polar code states of length N/2, according to an embodiment of the present invention.

In fact, the represented construction applies to any polar code of length K=2^{k}, k=1 to n, given two equivalent polar code states of length K/2. Furthermore, for any given K=2^{k}, k>0, two cases are to be considered, according to whether

$${i}_{j ( k )} > \frac{K}{2} or {i}_{j ( k )} \leq \frac{K}{2} ,$$

represented in FIGS. 8A and 8B respectively.

For simplicity of notation, we shall consider hereafter, the preparation of the polar code state of length N, given the output at the recursive level n−1, of two equivalent polar code states of length N/2. Hence, since iⱼ₍ₙ₎=i, the two cases to be distinguished are i>N/2 and i≤N/2. as represented in FIGS. 8A and 8B respectively.

In particular, the example in FIG. 8A schematically represents the preparation of polar code state C1 of length N using Pauli Z⊗Z measurement circuits 71, given two equivalent polar code states C2, C3 of length N/2, when i>N/2. The shorthand notation from FIG. 6A is used to represent Pauli Z⊗Z measurement circuits.

Let

$${i}^{′} := i - \frac{N}{2} ,$$

and [symbol] :={1, . . . ,i′}, and [symbol] :={i′+1, . . . , N/2}. Assume that the following two equivalent polar code states of length N/2 are already determined:

$${\vert {q}_{N / 2}^{1} 〉}_{{S}_{1}} := {Q}_{N / 2} \vert {u}_{1} , {\overline{v}}_{1} \qquad ( 34 )$$

$${\vert {q}_{N / 2}^{2} 〉}_{{S}_{2}} := {Q}_{N / 2} \vert {u}_{2} , {\overline{v}}_{2} \qquad ( 35 )$$

where binary vectors u₁, u₂∈{0, 1}^{i′} and binary vectors v₁,

$${v}_{2} ∈ {\{ 0 , 1 \}}^{\frac{N}{2} - {i}^{′}}$$

are known.

The method according to the invention corresponds to performing qubit wise Pauli Z⊗Z measurements on the corresponding qubits in systems [symbol] and [symbol] . The measurement outcome m is as follows:

$$m = {P}_{N / 2} ( {u}^{′} , x ) ∈ {\{ 0 , 1 \}}^{N / 2} \qquad ( 36 )$$

where binary vector u′=u₁⊕u₂∈{0, 1}^{i′}, and for some random binary vector

$$x ∈ {\{ 0 , 1 \}}^{\frac{N}{2} - {i}^{′}} .$$

After the measurements, we are left with the following polar code state of length N on the joint system [symbol] :

$$\vert {q}_{N} = {Q}_{N} \vert ( {u}^{′} , x , {u}_{2} ) , {\overline{v}}^{′} \qquad ( 37 )$$

where binary vector v′=v₁⊕v₂.

To prove that the polar code state |q_{N} [symbol] as expressed in Eq. (37) is obtained out of the Pauli Z⊗Z measurements on polar code states

$$\vert {q}_{N / 2}^{1} and \vert {q}_{N / 2}^{2} ,$$

we express these latter polar code states in the computational basis, as follows:

$$\begin{matrix}\vert {q}_{N / 2}^{1} = {Q}_{\frac{N}{2}} \vert ( {u}_{1} , \overline{{v}_{1}} ) \\ = {\sum }_{{x}_{1} ∈ {\{ 0 , 1 \}}^{\frac{N}{2} - {i}^{′}}} {( - 1 )}^{{v}_{1} \cdot {x}_{1}} {Q}_{\frac{N}{2}} \vert ( {u}_{1} , {x}_{1} ) \\ = {\sum }_{{x}_{1} ∈ {\{ 0 , 1 \}}^{\frac{N}{2} - {i}^{′}}} {( - 1 )}^{{v}_{1} \cdot {x}_{1}} \vert {P}_{N / 2} ( {u}_{1} , {x}_{1} )\end{matrix} , \qquad ( 38 )$$

where the normalization factors are ignored and where the third equality follows from Eq. (20).

On the other hand, the polar code state

$$\vert {q}_{N / 2}^{2}$$

can also be expressed in the computational basis similarly to Eq. (38).

As described in relation to FIG. 6A (where [symbol] and [symbol] are denoted as D₁ and D₂), the qubit wise Pauli Z⊗Z measurement is done according to the following two steps:

At the first step, an N/2 qubit ancilla state [symbol] :=|0 [symbol] ⊗ . . . ⊗ |0 [symbol] is defined and then qubit wise CNOT gates [symbol] and [symbol] are performed. This gives the following joint quantum state on [symbol] , [symbol] , and [symbol] :

$$:= {\sum }_{{x}_{1} , {x}_{2} ∈ {\{ 0 , 1 \}}^{\frac{N}{2} - {i}^{′}}} {( - 1 )}^{{v}_{1} \cdot {x}_{1} ⊕ {v}_{2} \cdot {x}_{2}} \vert {P}_{\frac{N}{2}} ( {u}_{1} , {x}_{1} ) \vert {P}_{\frac{N}{2}} ( {u}_{2} , {x}_{2} ) \vert {P}_{\frac{N}{2}} ( {u}_{1} ⊕ {u}_{2} , {x}_{1} ⊕ {x}_{2} ) \qquad ( 39 )$$

Then, at the second step, single qubit Pauli-Z measurement is done on each qubit in the ancilla system [symbol] . The measurement outcome gives m=P_{N/2}(u′, x), where u′=u₁⊕u₂∈{0, 1}^{i′}, and for some random

$$x ∈ {\{ 0 , 1 \}}^{\frac{N}{2} - {i}^{′}} .$$

The joint state of systems [symbol] and [symbol] after the measurements is as follows:

$$= {\sum }_{\begin{matrix}{x}_{1} , {x}_{2} ∈ {\{ 0 , 1 \}}^{\frac{N}{2} - {i}^{′}} \\ {x}_{1} ⊕ {x}_{2} = x\end{matrix}} {( - 1 )}^{{v}_{1} \cdot {x}_{1} ⊕ {v}_{2} \cdot {x}_{2}} \vert {P}_{\frac{N}{2}} ( {u}_{1} , {x}_{1} ) \vert {P}_{\frac{N}{2}} ( {u}_{2} , {x}_{2} ) \qquad ( 40 )$$

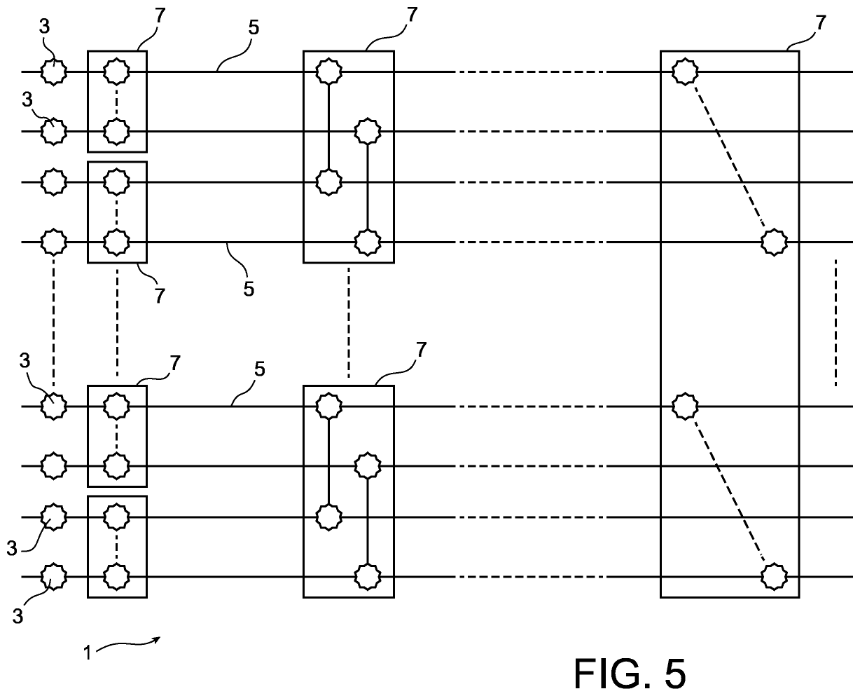

The above quantum state [symbol] corresponds to the polar code state |q_{N} [symbol] in Eq. (37), as shown by the following equations:

$$\begin{matrix}= {\sum }_{\begin{matrix}{x}_{1} , {x}_{2} ∈ {\{ 0 , 1 \}}^{\frac{N}{2} - {i}^{′}} \\ {x}_{1} ⊕ {x}_{2} = x\end{matrix}} {( - 1 )}^{{v}_{1} \cdot {x}_{1} ⊕ {v}_{2} \cdot {x}_{2}} \vert {P}_{\frac{N}{2}} ( {u}_{1} , {x}_{1} ) \vert {P}_{\frac{N}{2}} ( {u}_{2} , {x}_{2} ) \\ = {\sum }_{{x}_{2} ∈ {\{ 0 , 1 \}}^{\frac{N}{2} - {i}^{′}}} {( - 1 )}^{{v}_{1} \cdot ( x + {x}_{2} ) ⊕ {v}_{2} \cdot {x}_{2}} \vert {P}_{\frac{N}{2}} ( {u}^{′} ⊕ {u}_{2} , x ⊕ {x}_{2} ) \vert {P}_{\frac{N}{2}} ( {u}_{2} , {x}_{2} ) \\ = {( - 1 )}^{{v}_{1} \cdot x} {\sum }_{{x}_{2} ∈ {\{ 0 , 1 \}}^{N - i}} {( - 1 )}^{( {v}_{1} ⊕ {v}_{2} ) \cdot {x}_{2}} \vert {P}_{N} ( {u}^{′} , x , {u}_{2} , {x}_{2} ) \\ = {Q}_{N} \vert ( {u}^{′} , x , {u}_{2} ) , {\overline{v}}^{′}\end{matrix}$$

where the third equality follows from the recursion of polar transform given in FIG. 3A, and where v′=v₁⊕v₂ in the fourth equality. Finally, x can be determined from the measurement outcome.

In fact, Eq. (36), implies (u′, x)=P_{N/2}(m)

$$( using {P}_{N}^{2} = I ) ,$$

and therefore, x is determined as follows:

$$x = {P}_{N / 2} ( m ) {\vert}_{{𝒳}^{′}} \qquad ( 42 )$$

Hence, for the state |q_{N} [symbol] in Eq. (37), we have [symbol] ={1, . . . , i}, [symbol] ={i+1, . . . , N}, with

$$i = {i}^{′} + \frac{N}{2} ,$$

and the corresponding frozen states [symbol] =(u′, x, u₂) [symbol] , and [symbol] := [symbol] .

FIG. 8B schematically represents the preparation of polar code state C11 of length N, given two equivalent polar code states C12, C13 of length N/2, when i≤N/2, according to an example of the present invention.

Let [symbol] :={1, . . . , i′}, and

$${𝒳}^{′} := \{ {i}^{′} + 1 , … , \frac{N}{2} \} ,$$

where i′=i. We assume that we have been given the following equivalent polar code states of length N/2:

$$\vert {q}_{N / 2}^{1} := {Q}_{N / 2} \vert {u}_{1} , {\overline{v}}_{1} \qquad ( 43 )$$

$$\vert {q}_{N / 2}^{2} := {Q}_{N / 2} \vert {u}_{2} , {\overline{v}}_{2} \qquad ( 44 )$$

where binary vectors u₁, u₂∈{0, 1}^{i′} and v₁, v₂∈{0, 1}^{N/2-i′} are known.

In this case, the preparation method corresponds to performing qubit wise Pauli X⊗X measurement circuits 72 on the corresponding qubits in [symbol] and [symbol] .

Similar to the previous case, the outcome of Pauli X⊗X measurements gives:

$$m = {P}_{\frac{N}{2}}^{T} ( z , {v}^{′} ) ∈ {\{ 0 , 1 \}}^{N / 2} \qquad ( 45 )$$

where vector v′=v₁⊕v₂ and z∈{0,1}^{i′} is a random vector. After the measurements, we get the following polar code state:

$$\vert {q}_{N} = {Q}_{N} \vert {u}^{′} , \overline{( {v}_{1} , z , {v}^{′} )} \qquad ( 46 )$$

where u′=u₁⊕u₂, and z is determined from the measurement outcome in Eq. (45), as follows:

$$z = {P}_{N / 2}^{T} ( m ) {\vert}_{{𝒵}^{′}} \qquad ( 47 )$$

For the state |q_{N} [symbol] in Eq. (46), we have [symbol] ={1, . . . , i}, [symbol] ={i+1, . . . , N}, with i=i′, and the corresponding frozen states [symbol] = [symbol] , and [symbol] = [symbol] .

In the general case of preparing any polar code of length K=2^{k}, k=1 to n, given two equivalent polar code states of length K/2, index i=iⱼ₍ₙ₎ is to be replaced by iⱼ₍ₖ₎ and index i′=iⱼ₍ₙ₋₁₎ is to be replaced by iⱼ₍ₖ₋₁₎. Furthermore, frozen sets [symbol] = [symbol] ⱼ₍ₙ₎, [symbol] = [symbol] ⱼ₍ₙ₎, [symbol] = [symbol] ⱼ₍ₙ₋₁₎, and [symbol] = [symbol] ⱼ₍ₙ₋₁₎ are to be replaced by [symbol] ⱼ₍ₖ₎, [symbol] ⱼ₍ₖ₎, [symbol] ⱼ₍ₖ₋₁₎, and [symbol] ⱼ₍ₖ₋₁₎, respectively. The two equivalent polar code states

$${{\vert {q}_{N / 2}^{1} 〉}_{{δ}_{1}} and \vert {q}_{N / 2}^{2} 〉}_{{δ}_{2}} ,$$

on which Pauli Z⊗Z or Pauli X⊗X measurement circuits are applied, are to be replaced by two equivalent polar code states

$$\vert {q}_{K / 2}^{1} {}_{( k - 1 )} and \vert {q}_{K / 2}^{2} {( k - 1 )}_{} .$$

Hence, for any level of recursion k, the quantum polar code [symbol] is associated on the one hand, to the frozen states [symbol] = [symbol] , and [symbol] := [symbol] when the Pauli Z⊗Z measurement circuits were applied on the corresponding qubits at the recursive level k−1, and on the other hand, to the frozen states [symbol] = [symbol] , and [symbol] = [symbol] when the Pauli X⊗X measurement circuits were applied on the corresponding qubits of the precedent recursive level k−1. The above frozen states are defined such that, u′=u₁⊕u₂, v′=v₁⊕v₂, u₁, u₂∈{0, 1}ⁱ^{_{j(k−1)}}, v₁, v₂∈{0, 1}_{z}^{K/2-i}^{_{j(k−1)}}, with iⱼ₍ₖ₋₁₎=iⱼ₍ₖ₎−2^{k-1}, for Pauli Z⊗Z measurements and with iⱼ₍ₖ₋₁₎=iⱼ₍ₖ₎, for Pauli X⊗X measurements. The two equivalent polar code states

$${{\vert {q}_{{2}^{k - 1}}^{1} 〉}_{{( k - 1 )}_{}} and \vert {q}_{{2}^{k - 1}}^{2} 〉}_{{( k - 1 )}_{}}$$

from the precedent recursive level k−1, on which the Pauli Z⊗Z or Pauli X⊗X measurement circuits were applied, were associated with frozen states [symbol] , [symbol] and [symbol] , [symbol] , respectively. Vectors x and z are estimated on the basis of the measurement outcome m of the corresponding Pauli measurement circuits and corresponding polar transform P_{K/2} or

$${P}_{K / 2}^{T}$$

using x=P_{K/2}(m) [symbol] when the Pauli Z⊗Z measurement circuits were applied on the corresponding qubits at the recursive level k−1, and z=

$${{P}_{K / 2}^{T} ( m ) \vert}_{{𝓏}_{j ( k - 1 )}}$$

when the Pauli X⊗X measurement circuits were applied on the corresponding qubits of the precedent recursive level k−1.

In the particular case k=n (i.e. K=N), the quantum polar code |q_{N} [symbol] is associated on the one hand, to the frozen states [symbol] = [symbol] , and [symbol] := [symbol] when the Pauli Z⊗Z measurement circuits were applied on the corresponding qubits of the precedent recursive level k=n−1, and on the other hand, to the frozen states [symbol] = [symbol] , and [symbol] = [symbol] , when the Pauli X⊗X measurement circuits were applied on the corresponding qubits of the precedent recursive level k=n−1. In this case, u′=u₁⊕u₂∈{0, 1}^{i′}, v′=v₁⊕v₂, u₁, u₂∈{0,1}^{i′}, v₁, v₂={0, 1}^{N/2-i′}, and i′=i−N/2 for Pauli Z⊗Z measurements and with i′=i, for Pauli X⊗X measurements. Vectors x and z are estimated on the basis of the measurement outcome m of the corresponding Pauli measurement circuits according to Eqs. (43) and (48), respectively.

In the following, we restrict again the discussion to the case k=n, thus K=N, but again, this is only for simplicity of notation and consistency with the previous detailed description of FIGS. 8A and 8B.

As described above, the binary vectors x and z are estimated on the basis of the measurement outcome m of the corresponding Pauli measurement circuits, and corresponding polar transform, either P_{N/2} or

$${P}_{N / 2}^{T} ,$$

according to Eqs. (42) and (47), respectively.

In fact, the fault tolerance according to the method of the present invention comes down to estimating the binary vectors x and z in Eqs. (42) and (47), respectively, from the measurement outcomes of Pauli Z⊗Z, or Pauli X⊗X measurements.

In what follows, for a binary vector u=(u₁, . . . , u_{N})∈{0, 1}^{N}, we define sup (u):={i|uᵢ=1, i∈{1, . . . , N}}, and wt(u):=|sup(u)|. Moreover, for a set [symbol] ⊂{1, . . . , N}, we define [symbol] [symbol] to be the part of u corresponding to the indices in [symbol] .

To consider the preparation procedure of polar code states, under the effect of noise, we suppose that noise acts on each qubit independently, and it causes random Pauli errors on each qubit, with some probability. The preparation method is said to be fault tolerant if for any N, the errors on quantum states

$${{\vert {q}_{N / 2}^{1} 〉}_{{δ}_{1}} and \vert {q}_{N / 2}^{2} 〉}_{{δ}_{2}}$$

do not propagate to an increased number of qubits in |q_{N} [symbol] .

In the case i>N/2, instead of Eqs. (43) and (44), we have the following error corrupted polar code states of length N/2:

$${{\vert {q}_{N / 2}^{1} 〉}_{{δ}_{1}} := {X}^{{e}_{{X}_{1}}} {Z}^{{e}_{{Z}_{1}}} {Q}_{N / 2} \vert {u}_{1} , {\overline{v}}_{1} 〉}_{{δ}_{1}} \qquad ( 48 )$$

$${{\vert {q}_{N / 2}^{2} 〉}_{{δ}_{2}} := {X}^{{e}_{{X}_{2}}} {Z}^{{e}_{{Z}_{2}}} {Q}_{N / 2} \vert {u}_{2} , {\overline{v}}_{2} 〉}_{{δ}_{2}} \qquad ( 49 )$$

where binary u₁, u₂∈{0, 1}^{i′} and v₁, v₂∈{0, 1}^{N/2-i′} are known, with

$${i}^{′} = i - \frac{N}{2} ,$$

and the binary vector errors e_{X}_{₁}, e_{Z}_{₁}, e_{X}_{₂},

$${e}_{{Z}_{2}} ∈ {\{ 0 , 1 \}}^{\frac{N}{2}}$$

are unknown.

For simplicity, we start by assuming that Pauli Z⊗Z measurements can be performed perfectly, without errors.

The qubit wise Pauli Z⊗Z measurements on the corresponding qubits of [symbol] and [symbol] of Eqs. (48) and (49), give the following measurement m:

$$m = {P}_{N / 2} ( {u}^{′} , x ) ⊕ {e}_{X} ∈ {\{ 0 , 1 \}}^{\frac{N}{2}} \qquad ( 50 )$$

where u′=u₁⊕u₂ is known, and

$$x ∈ {\{ 0 , 1 \}}^{\frac{N}{2} - {i}^{′}} ,$$

e_{X}:=e_{X}_{₁}⊕e_{X}_{₂}, are unknown. After the measurements, the error corrupted polar code state on N qubits, depends on vector x according to the following expression:

$${{\vert {q}_{N} 〉}_{{δ}_{1} {δ}_{2}} = {X}^{{\overline{e}}_{X}} {Z}^{{\overline{e}}_{Z}} {Q}_{N} \vert ( {u}^{′} , x , {u}_{2} , {\overline{v}}^{′} ) 〉}_{{δ}_{1} {δ}_{2}} \qquad ( 51 )$$

where v′=v₁⊕v₂, \tilde{e}_{X}=(e_{X}_{₁}, e_{X}_{₂}), and \tilde{e}_{Z}=(e_{Z}_{₁}, e_{Z}_{₂}).

The X (respectively, Z) error on [symbol] is simply equal to the X (respectively, Z) errors on

$${{\vert {q}_{N / 2}^{1} 〉}_{{δ}_{1}} and \vert {q}_{N / 2}^{2} 〉}_{{δ}_{2}}$$

and thus, the method of preparation according to the present invention is fault tolerant.

However, in order to know the prepared polar code state, the vector x in Eq. (51) has to be estimated. Note that, in case no error occurs, that is e_{X}=0 in Eq. (50), then the vector x can be determined as in Eq. (42). However, if an unknown error e_{X}≠0 occurs in Eq. (50), the equality in Eq. (42) for x does not hold anymore.

To estimate the vector x, two techniques can be used, one based on error detection, and the other one based on error correction.

The error-detection based technique exploits the redundancy of measurements in the described preparation procedure. As described above in relation to FIG. 8A, let [symbol] :={1, . . . , i′}, and

$${𝒳}^{′} := \{ {i}^{′} + 1 , … , \frac{N}{2} \} .$$

After getting the measurement outcome m in Eq. (50), it is verified whether the equality [symbol] =u′ holds or not.

If [symbol] =u′, then the syndrome of the error e_{X} is zero, that is [symbol] =0. Hence, it is assumed that no error occurred, and the value of vector x is estimated according to Eq. (42), that is x= [symbol] .

If [symbol] ≠u′, then it is deduced that some error has occurred. Hence, the procedure is discarded and restarted, by taking fresh polar code states of length N/2.

In the general case, i.e., at any level k, when the Pauli Z⊗Z measurement circuits were applied on the corresponding qubits at the recursive level k−1, it is verified whether the equality [symbol] =u′ holds or not. If [symbol] =u′, then the vector x is estimated using x= [symbol] , or otherwise it is discarded and the procedure is restarted by taking fresh polar code states of length K/2.

The error-correction based technique also exploits the redundancy of measurements in the described preparation procedure, but it determines the vector x using a maximum likelihood decision rule as follows.

As described above in relation to FIG. 8A, and going back to the specific case K=N (for the simplicity and consistency of notation), let [symbol] :={1, . . . , i′}, and

$${𝒳}^{′} := \{ {i}^{′} + 1 , … , \frac{N}{2} \} .$$

Further, for an i″ such that

$${i}^{′} < {i}^{″} \leq \frac{N}{2} ,$$

we define [symbol] :={i′+1, . . . , i″}⊆ [symbol] , and

$${𝒳}_{r}^{″} := {𝒳}^{′} ∖ {𝒳}^{″} .$$

Hence, the binary vector x can be defined as follows:

$$x = ( x {\vert}_{{𝒳}^{″}} , x {\vert}_{{𝒳}_{r}^{″}} ) \qquad ( 52 )$$

The

$$x {\vert}_{{𝒳}_{r}^{″}}$$

part of x in Eq. (52) is estimated from the measurement outcome m in Eq. (50), as follows:

$$x {\vert}_{{𝒳}_{r}^{″}} = {P}_{\frac{N}{2}} ( m ) {\vert}_{{𝒳}_{r}^{″}} \qquad ( 53 )$$

A maximum likelihood decision for the x|_{x″} part of x in Eq. (52), is then determined as follows:

$$x {\vert}_{{𝒳}^{″}} = arg {min}_{a \vert {𝒳}^{″}} wt ( m ⊕ {P}_{\frac{N}{2}} ( {u}^{′} , a {\vert}_{{𝒳}^{″}} , \hat{x} {\vert}_{{𝒳}_{r}^{′}} ) ) \qquad ( 54 )$$

When x|_{x″} is not unique, meaning that there are several values a|_{x″} giving the minimum weight

$$m ⊕ {P}_{\frac{N}{2}} ( u , a {\vert}_{{𝒳}^{″}} , x {\vert}_{{𝒳}_{r}^{″}} ) ,$$

the procedure is discarded and restarted again, by taking fresh polar code states of length N/2.

Finally, the above assumption that Pauli Z⊗Z measurements are perfect is not needed and may be relaxed. In fact, when Pauli Z⊗Z measurements are noisy, an extra error e′_{X} on the measurement outcome m is introduced in Eq. (50), which becomes m=P_{N/2}(u′, x)⊕e_{X}⊕e′_{X}.

However, [symbol] in Eq. (51) remains the same, except possibly an extra error introduced upon it by the noisy measurement.

In the case i≤N/2, instead of Eqs. (43) and (44), we have the following error corrupted polar code states of length N/2:

$${{\vert {q}_{N / 2}^{1} 〉}_{{δ}_{1}} := {X}^{{e}_{{X}_{1}}} {Z}^{{e}_{{Z}_{1}}} {Q}_{N / 2} \vert {u}_{1} , {\overline{v}}_{1} 〉}_{{δ}_{1}} \qquad ( 55 )$$

$${{ \vert {q}_{N / 2}^{2} 〉}_{{δ}_{2}} := {X}^{{e}_{{X}_{2}}} {Z}^{{e}_{{Z}_{2}}} {Q}_{N / 2} \vert {u}_{2} , {\overline{v}}_{2} 〉}_{{δ}_{2}} \qquad ( 56 )$$

where u₁, u₂∈{0, 1}^{i′} and v₁, v₂∈{0, 1}^{N/2-i′} are known, with i′=i, and the errors e_{X}_{₁}, e_{Z}_{₁}, e_{X}_{₂},

$${e}_{{Z}_{2}} ∈ {\{ 0 , 1 \}}^{\frac{M}{2}}$$

are unknown.

The qubit wise Pauli X⊗X measurements on the corresponding qubits of [symbol] and [symbol] of Eqs. (55) and (56) give the following:

$$m = {P}_{N / 2}^{T} ( z , {v}^{′} ) ⊕ {e}_{Z} ∈ {\{ 0 , 1 \}}^{\frac{N}{2}} \qquad ( 57 )$$

where

$${v}^{′} = {v}_{1} ⊕ {v}_{2} ∈ {\{ 0 , 1 \}}^{\frac{N}{2} - {i}^{′}}$$

is know, and z∈{0,1}^{i′},

$${e}_{Z} = {e}_{{Z}_{1}} ⊕ {e}_{{Z}_{2}} ∈ {\{ 0 , 1 \}}^{\frac{N}{2}}$$

are unknown.

After the measurements, the error corrupted polar code state on N qubits depends on vector x according to the following expression:

$${{\vert {q}_{N} 〉}_{{δ}_{1} {δ}_{2}} = {X}^{{\overline{e}}_{X}} {Z}^{{\overline{e}}_{Z}} {Q}_{N} \vert {u}^{′} , \overline{( {v}_{1} , z , {v}^{′} )} 〉}_{{δ}_{1} {δ}_{2}} \qquad ( 58 )$$

where u′=u₁⊕u₂∈{0,1}^{i′}, \tilde{e}_{X}=(e_{X}_{₁}, e_{X}_{₂}) and z=(e_{Z}_{₁}, e_{Z}_{₂}).

Similarly, in order to know the prepared polar code state, the vector z has to be estimated. To estimate the vector z, two methods can be used, one based on error detection, and the other one based on error correction.

The error-detection based method exploits the redundancy of measurements in the described preparation procedure. As described above in relation to FIG. 8B, let [symbol] :={1, . . . , i′}, and

$${𝒳}^{′} := \{ {i}^{′} + 1 , … , \frac{N}{2} \} .$$

After getting the measurement outcome m in Eq. (57), it is verified if the and equality

$${P}_{N / 2}^{T} ( m ) {\vert}_{{𝒳}^{′}} = {v}^{′}$$

holds.

If

$${P}_{N / 2}^{T} ( m ) {\vert}_{{𝒳}^{′}} = {v}^{′} ,$$

then the syndrome of the error e_{Z} is zero, that is

$${P}_{N / 2}^{T} ( {e}_{Z} ) {\vert}_{{𝒳}^{′}} = 0.$$

Hence, it is assumed that no error occurred, and the value of vector z is estimated according to Eq, (47), that is

$$z = {P}_{N / 2}^{T} ( m ) {\vert}_{{𝒵}^{′}} .$$

If

$${P}_{N / 2}^{T} ( m ) {\vert}_{{𝒳}^{′}} \neq {v}^{′} ,$$

then it is deduced that some error has occurred. Hence, the procedure is discarded and restarted, by taking fresh polar code states of length N/2.

In the general case, i.e., at any level k, when the Pauli X⊗X measurement circuits were applied on the corresponding qubits at the recursive level k−1, it is verified whether the estimated using

$${P}_{N / 2}^{T} ( m ) {\vert}_{{𝒳}_{j ( k - 1 )}} = {v}^{′}$$

$${P}_{N / 2}^{T} ( m ) {\vert}_{{𝒳}_{j ( k - 1 )}} = {v}^{′} ,$$

$$z = {P}_{N / 2}^{T} ( m ) {\vert}_{{𝒵}_{j ( k - 1 )}} ,$$

or otherwise it is discarded and the procedure is restarted by taking fresh polar code states of length K/2.

The error-correction based method also exploits the redundancy of measurements in the described preparation procedure, but it determines the vector z using a maximum likelihood decision rule.

As described above with relation to FIG. 8B, let [symbol] :={1, . . . , i′}, and

$${𝒳}^{′} := \{ {i}^{′} + 1 , … , \frac{N}{2} \} .$$

Further for an i″, such that 1≤i″≤i′+1, let [symbol] :={i″, . . . , i′}⊆ [symbol] , and

$${𝒵}_{r}^{″} := {𝒵}^{′} \backslash {𝒵}^{″} .$$

Hence, the binary vector z can be defined as follows:

$$z = ( z {\vert}_{{𝒵}_{r}^{″}} , z {\vert}_{{𝒵}_{r}^{″}} ) \qquad ( 59 )$$

The

$$z {\vert}_{{𝒵}_{r}^{″}}$$

part of z in Eq. (59), is estimated from the measurement outcome m in Eq. (57), as follows:

$$z {\vert}_{{𝒵}_{r}^{″}} = {P}_{N / 2}^{T} ( m ) {\vert}_{{𝒵}_{r}^{″}} \qquad ( 60 )$$

A maximum likelihood decision for the [symbol] part of z in Eq. (59), is then determined as follows:

$$z {\vert}_{{𝒵}^{″}} ′ = arg {min}_{b {\vert}_{{𝒵}^{″}}} wt ( m ⊕ {P}_{N / 2} ( z {\vert}_{{𝒵}_{r}^{″}} , b {\vert}_{{𝒵}^{″}} , v ) ) \qquad ( 61 )$$

When [symbol] is not unique, meaning that there are several [symbol] giving the minimum weight

$$wt ( m ⊕ {P}_{N / 2} ( z {\vert}_{{𝒵}_{r}^{″}} , b {\vert}_{{𝒵}^{″}} , v ) ) ,$$

the procedure is discarded and restarted again, by taking fresh polar code states of length N/2.

In the general case, i.e., at any level k, the fault tolerant preparation of quantum polar code states is represented by the estimation of vectors x and z. The binary vector x is defined as

$$x = ( x {\vert}_{{𝒳}^{″}} , x {\vert}_{{𝒳}_{r}^{″}} )$$

with respect to the sets

$${𝒳}_{j ( k - 1 )} = \{ {i}_{j ( k - 1 )} + 1 , … , \frac{K}{2} \} ,$$

[symbol]

:={iⱼ₍ₖ₋₁₎+1, . . . , i″}⊆ [symbol] ₍ₖ₋₁₎ and

$${𝒳}_{r}^{″} := {𝒳}_{j ( k - 1 )} \backslash {𝒳}^{″} , with {i}_{j ( k - 1 )} \leq {i}^{″} \leq \frac{K}{2} ,$$

and where

$$x {\vert}_{{𝒳}_{r}^{″}} = {P}_{K / 2} ( m ) {\vert}_{{𝒳}_{r}^{″}} and x {\vert}_{{𝒳}^{″}} = arg {min}_{a {\vert}_{{𝒳}^{″}}} wt ( m ⊕ {P}_{K / 2} ( {u}^{′} , a {\vert}_{{𝒳}^{″}} , x {\vert}_{{𝒳}_{r}^{″}} ) .$$

The binary vector z is defined as

$$z = ( z {\vert}_{{𝒵}_{r}^{″}} , z {\vert}_{{𝒵}^{″}} ) ,$$

with respect to the sets [symbol] ₍ₖ₋₁₎={1, . . . , iⱼ₍ₖ₋₁₎}, [symbol] :={i″, . . . , iⱼ₍ₖ₋₁₎}⊆ [symbol] ₍ₖ₋₁₎, and

$${𝒵}_{r}^{″} := {𝒵}_{j ( k - 1 )} \backslash {𝒵}^{″} ,$$

with 1≤i″≤iⱼ₍ₖ₋₁₎+1, and where

$$z {\vert}_{{𝒵}_{r}^{″}} = {P}_{K / 2}^{T} ( m ) {\vert}_{{𝒵}_{r}^{″}} and z {\vert}_{{𝒵}^{″}} = arg {min}_{b {\vert}_{{𝒵}^{″}}} wt ( m ⊕ {P}_{K / 2} ( z {\vert}_{{𝒵}_{r}^{″}} , b {\vert}_{{𝒵}^{″}} , v ) ) .$$

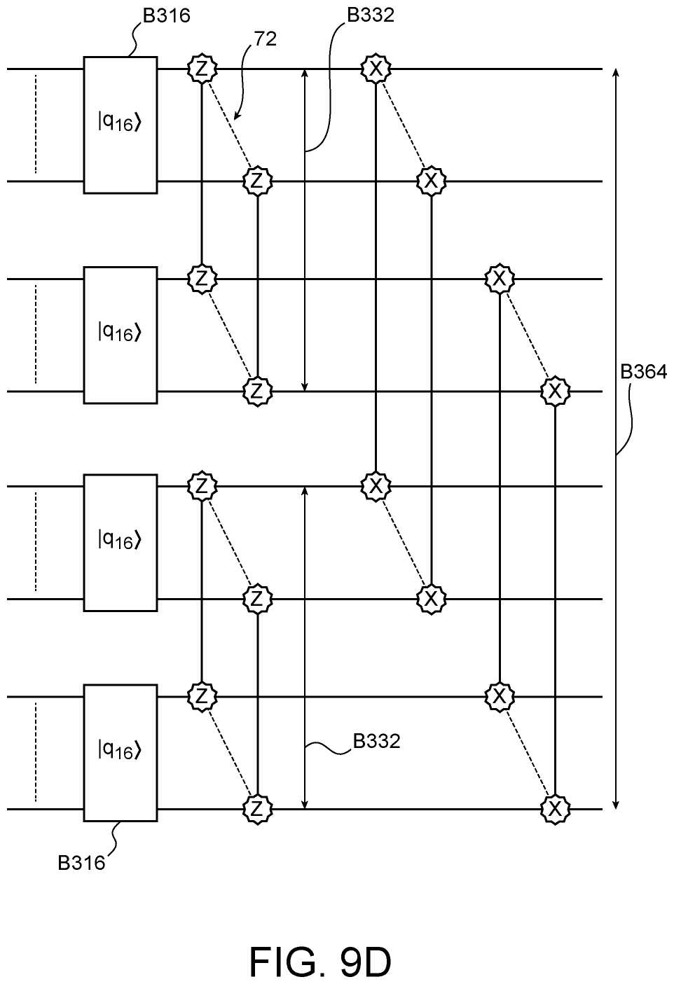

FIGS. 9A, 9B, 9C and 9D schematically represent different examples of fault tolerant preparation of quantum polar code states, according to an embodiment of the present invention.

The four examples concern fault tolerant preparation of polar code states using Pauli Z⊗Z and X⊗X measurements, recursively. For these examples, the sets [symbol] and [symbol] , are specified at each level of recursion.

To ensure fault-tolerance, one of the two techniques described above can be used, based on either error detection or error correction.

To implement the error detection based technique, only the sets [symbol] and [symbol] , and the measurement outcome m, have to be specified.

Further, for the error-correction based technique, when qubit wise Pauli Z⊗Z measurements are performed, the set [symbol] (hence, also

$${𝒳}_{r}^{″} )$$

is specified, and thus Eqs. (53) and (54) are used to estimate vector x. When qubit wise Pauli X⊗X measurements are performed, the set [symbol] (hence, also

$${𝒵}_{r}^{″} )$$

is specified, and thus, Eqs. (60) and (61) are used to estimate vector z.

In the description of FIGS. 9A, 9B, 9C and 9D, we consider the example of error-correction based technique.

In particular, FIG. 9A concerns the recursive preparation of a quantum polar code |q₈ [symbol] of length N=8 with [symbol] ={1,2,3} and [symbol] ={4,5,6,7,8}.

A single qubit Pauli Z measurement is performed on each qubit such to initialize them into a computational basis state. Alternatively, any other method to initialize the qubits in the computational basis can be used.

Then, at each level of recursion, polar code states of lengths N=2, 4, 8 are prepared, as follows:

At the first level of recursion, four polar code states

$$\{ \vert {q}_{2}^{1} 〉 , \vert {q}_{2}^{2} 〉 , \vert {q}_{2}^{3} 〉 , \vert {q}_{2}^{4} 〉 \}$$

of length N=2, with [symbol] ={1} and [symbol] ={2} are prepared represented by the four blocks B2. Here, [symbol] ={1} and [symbol] ={2} refer to the first and second qubit of each of the four blocks B2. Here [symbol] ={1}, [symbol] =Ø, and [symbol] =Ø, hence

$${𝒵}_{r}^{″} = {𝒵}^{′} .$$

The estimate or z∈{0,1} is determined from Eq. (60), as follows:

$$z = {P}_{1}^{T} ( m ) {\vert}_{{𝒵}^{′}} = m , where m ∈ \{ 0 , 1 \} \qquad ( 62 )$$

At the second level of recursion, two polar code states

$$\{ \vert {q}_{4}^{1} 〉 , \vert {q}_{4}^{2} 〉 \}$$

of length N=4, with [symbol] ={1,2,3} and [symbol] ={4} are prepared, represented by the two blocks B4. Here, [symbol] ={1,2,3} and [symbol] ={4} refer to the first, second, third, and fourth qubit of each of the two blocks B4. Then, [symbol] ={1}, [symbol] ={2}, and [symbol] =Ø, hence

$${𝒳}_{r}^{″} = {𝒳}^{′} .$$

The estimate of x∈{0,1} is determined from Eq. (53), as follows:

$$x = {P}_{2} ( m ) {\vert}_{{𝒳}^{′}} = {m}_{1} ⊕ {m}_{2} , where m = ( {m}_{1} , {m}_{2} ) ∈ {\{ 0 , 1 \}}^{2} \qquad ( 63 )$$

Finally, at the third level of recursion, the desired polar code state |q₈ [symbol] of length N=8, with [symbol] ={1,2,3} and [symbol] ={4,5,6,7,8} is prepared, represented by the single blocks B8. Here [symbol] ={1,2,3}, [symbol] ={4}, and [symbol] =Ø, hence

$${𝒵}_{r}^{″} = {𝒵}^{′} .$$

Ine estimate or z∈{0,1}³ is determined from Eq. (60), as follows:

$$z = {P}_{4}^{T} ( m ) {\vert}_{{𝒵}^{′}} = ( {m}_{1} , {m}_{1} ⊕ {m}_{2} , {m}_{1} ⊕ {m}_{3} ) , \qquad ( 64 )$$

where m=(m₁, m₂, m₃, m₄)∈{0,1}⁴.

FIG. 9B concerns the recursive preparation of a quantum polar code |q₁₆ [symbol] of length N=16, with [symbol] ={1, . . . , 7} and [symbol] ={8, . . . ,16}.

The first two levels of recursion are the same as the first two level of recursions in FIG. 9A, except that there are twice as many polar code states of length N=2 represented by the eight blocks B12, and twice as many polar code states of length N=4 represented by the four blocks B14. Thus, only the third and fourth levels of recursion will be described hereafter.

At the third level of recursion, two polar code states of length N=8, with [symbol] ={1, . . . , 7} and [symbol] ={8} are prepared, represented by the two blocks B18. Here, [symbol] ={1,2,3} and [symbol] ={4}, then, [symbol] = [symbol] ={4}, hence

$${𝒳}_{r}^{″} = ∅ .$$

The estimate of x∈{0,1} is then determined from Eq. (54), as follows:

$$x = arg {min}_{a ∈ \{ 0 , 1 \}} wt ( m ⊕ {P}_{4} ( {u}^{′} , a ) ) \qquad ( 65 )$$

Recall that if x is not unique, the prepared state of length N=8 is discarded without proceeding to the next level of recursion and the whole procedure is restarted back from the initialization.

Finally, at the fourth level of recursion, the desired polar code state |q₁₆ [symbol] of length N=16, with [symbol] ={1, . . . , 7} and [symbol] ={8, . . . ,16} is prepared, represented by the single block B116. We have [symbol] ={1, . . . , 7}, [symbol] ={8}, and [symbol] =Ø, hence

$${𝒵}_{r}^{″} = {𝒵}^{′} .$$

The estimate of z∈{0,1}′ is then determined from Eq. (60), as follows:

$$z = {P}_{8}^{T} ( m ) {\vert}_{{𝓏}^{′}} = ( {m}_{1} , {m}_{1} ⊕ {m}_{2} , {m}_{1} ⊕ {m}_{3} , {m}_{1} ⊕ {m}_{2} ⊕ {m}_{3} ⊕ {m}_{4} , {m}_{1} ⊕ {m}_{5} , {m}_{1} ⊕ {m}_{2} ⊕ {m}_{5} ⊕ {m}_{6} , {m}_{1} ⊕ {m}_{3} ⊕ {m}_{5} ⊕ {m}_{7} ) \qquad ( 66 )$$

where m=(m₁, . . . , m₈)∈{0,1}⁸.

FIG. 9C concerns the recursive preparation of a quantum polar code |q₁₆ [symbol] of length N=16, with [symbol] ={1, . . . , 11} and [symbol] ={12, . . . ,16}.

At the first two levels of recursion, eight polar code states of length N=2 and four polar code states of length N=4 are prepared, represented by eight blocks B22 and four blocks B24, respectively.

At the third level of recursion, two instances of polar code states of length N=8, represented by two blocks B28, with [symbol] ={1,2,3} and [symbol] ={4,5,6,7,8}, are prepared. This third level is similar to the third level of the first example depicted in FIG. 9A which was already described. Hereafter, we describe the fourth level of recursion.

At the fourth level of recursion, the desired polar code state |q₁₆ [symbol] of length N=16, with [symbol] ={1, . . . , 11} and [symbol] ={12, . . . ,16} is prepared, represented by a single block B216. Here, [symbol] ={1,2,3} and [symbol] ={4,5,6,7,8}. We take [symbol] ={4}, and hence

$${𝒳}_{r}^{″} = \{ 5 , 6 , 7 , 8 \} .$$

From Eq. (53), the

$$x {\vert}_{{𝒳}_{r}^{″}} ∈ {\{ 0 , 1 \}}^{4}$$

part or x is estimated, as follows:

$$x {\vert}_{{𝒳}_{r}^{″}} = {P}_{8} ( m ) {\vert}_{{𝒳}_{r}^{″}} = ( {m}_{5} ⊕ {m}_{6} ⊕ {m}_{7} ⊕ {m}_{8} , {m}_{6} ⊕ {m}_{8} , {m}_{7} ⊕ {m}_{8} , {m}_{8} ) \qquad ( 67 )$$

where m=(m₁, . . . , m₈)∈{0,1}⁸.

From Eq. (54), the [symbol] ∈{0,1} part of x is estimated, as follows:

$$x {\vert}_{{𝒳}^{″}} = arg {min}_{a ∈ \{ 0 , 1 \}} wt ( m ⊕ {P}_{8} ( {u}^{′} , a , x {\vert}_{{𝒳}_{r}^{″}} ) ) \qquad ( 68 )$$

If [symbol] is not unique, the prepared state of length N=16 is discarded and the whole procedure is restarted back from the initialization.

FIG. 9D concerns the recursive preparation of a quantum polar code |q₆₄ [symbol] of length N=64, with [symbol] ={1, . . . , 23} and [symbol] ={24, . . . ,64}.

Here, after the fourth level of recursion, we have four blocks B316 of polar code states of length N=16, with [symbol] ={1, . . . , 7} and [symbol] ={8, . . . ,16}, as in the second example described in relation to FIG. 9B. Below, only the remaining two levels of recursion are described.

At the fifth level of recursion, two polar code states of length N=32, with [symbol] ={1, . . . , 23} and [symbol] ={24, . . . ,32}, represented by the two blocks B332 are prepared. Here, we have [symbol] ={1, . . . , 7} and [symbol] ={8, . . . ,16}. We take [symbol] ={8}, and hence

$${𝒳}_{r}^{″} = \{ 9 , … , 16 \} .$$

From Eq. (53), the

$$x {\vert}_{{𝒳}_{r}^{′}} ∈ {\{ 0 , 1 \}}^{8}$$

part or x is estimated, that is,

$$x {\vert}_{{𝒳}_{r}^{″}} = {P}_{16} ( m ) {\vert}_{{𝒳}_{r}^{″}} ,$$

where m∈{0,1}¹⁶.

Further, from Eq. (54), we get the estimate

$$x {\vert}_{{𝒳}^{″}} = arg {min}_{a ∈ \{ 0 , 1 \}} wt ( m ⊕ {P}_{8} ( {u}^{′} , a , x {\vert}_{{𝒳}_{r}^{″}} ) ) ∈ \{ 0 , 1 \} .$$

At the sixth level of recursion, the desired polar code state |q₆₄ [symbol] of length N=64, with [symbol] ={1, . . . , 23} and [symbol] ={24, . . . ,64} is prepared, represented by the ingle block B364. Here, we have [symbol] ={1, . . . , 23} and [symbol] ={24, . . . ,32}. We take [symbol] =Ø, and hence

$${𝒵}_{r}^{″} = {𝒵}^{′} .$$

From Eq. (60), we get the estimate of z∈{0,1}²³, that is,

$$z = {P}_{32}^{T} ( m ) {\vert}_{{𝓏}^{′}} ,$$

where m∈{0,1}³².

The fault tolerant preparation of polar code states according to the embodiments of the present invention is an important resource for exploiting quantum polar codes for fault tolerant systems of quantum computation.

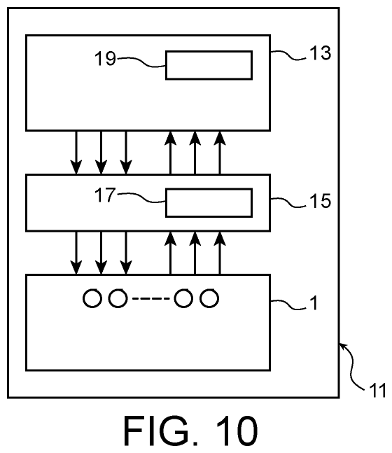

FIG. 10 schematically represents a computing system according to a preferred embodiment of the present invention.

The computing system 11 comprises a classical computing system 13, a classical-quantum interface 15 and a quantum computing system 1 configured to prepare quantum polar codes according to the above embodiments of the present invention. The quantum computing system 1 is coupled to the classical computing system 13 via the classical-quantum interface 15.

The classical-quantum interface 15 comprises a syndrome extractor 17 configured to extract a syndrome out of quantum measurements implemented by the quantum computing system 1.

The classical computing system 13 comprises a classical decoder 19 configured to decode the quantum polar codes prepared according to the above methods by implementing successive cancelation decoding.

1. A method of preparation of quantum polar code states in a quantum computing system materializing qubits, quantum gates and quantum circuits, comprising:
preparing an initial quantum system [symbol] ={1, . . . ,N}, of N=2ⁿ single-qubit states associated to an initial quantum base,
preparing a quantum polar code |q₂_{ⁿ} [symbol] of codelength N=2ⁿ referenced by predetermined first and second sets of frozen indices [symbol] ={1, . . . ,i}, [symbol] ={i+1, . . . , N} with respect to first and second quantum bases respectively, the quantum polar code |q₂_{ⁿ} [symbol] being prepared by recursively using two qubit Pauli measurement P⊗P circuits, and
at each recursive level k, where k=1 to n, preparing a set of 2ⁿ/2^{k} quantum polar code states {|q_(2\hat{ }k)>_( [symbol] _j(k)),j(k)=1 to (2\hat{ }n)/2\hat{ }k} of codelengths 2^{k}, referenced by corresponding sets [symbol] ⱼ₍ₖ₎ of indices comprising first and second sets of frozen indices [symbol] ⱼ₍ₖ₎={1ⱼ, . . . , iⱼ₍ₖ₎} and
$${𝒳}_{j ( k )} = \{ ( i + 1 ) {j ( k )}_{} , … , {2}_{j ( k )}^{k} \} ,$$
wherein
each quantum polar code state [symbol] is prepared by applying two qubit Pauli measurement P⊗P circuits on two equivalent polar code states
$${{\vert {q}_{{2}^{k} - 1}^{1} 〉}_{{δ}_{j ( k - 1 )}^{1}} and \vert {q}_{{2}^{k} - 1}^{2} 〉}_{{δ}_{j ( k - 1 )}^{2}}$$
belonging to an output of an antecedent recursive level k−1 and referenced by two corresponding sets of indices
$${δ}_{j ( k - 1 )}^{1} and {δ}_{j ( k - 1 )}^{2}$$
each of which comprising first and second sets of frozen indices [symbol] ⱼ₍ₖ₋₁₎ and [symbol] ⱼ₍ₖ₋₁₎ corresponding to first and second quantum bases respectively, the antecedent of the recursive level k=1 being the initial quantum system of single-qubit states.

2. The method of preparation of quantum polar code states according to claim 1, wherein the initial quantum system of single-qubit states is prepared by applying a single-qubit Pauli measurement P circuit on each qubit of a predetermined input of N qubit quantum states.

3. The method of preparation of quantum polar code states according to claim 2, wherein the single-qubit Pauli measurement circuit is a Z measurement circuit and the initial quantum base is a computational base.

4. The method of preparation of quantum polar code states according to claim 1, wherein the first and second quantum bases are computational and phase bases states respectively.

5. The method of preparation of quantum polar code states according to claim 1, wherein at the recursive level k, the two-qubit Pauli measurement P⊗P circuits applied on the two equivalent polar code states
$$\vert {q}_{{2}^{k - 1}}^{1} {( k - 1 )}_{} and \vert {q}_{{2}^{k - 1}}^{2} {( k - 1 )}_{}$$
are Z⊗Z Pauli measurement circuits when a last index iⱼ₍ₖ₎ of the corresponding first set of indices [symbol] ⱼ₍ₖ₎:={1ⱼ, . . . , iⱼ₍ₖ₎} is greater than 2^{k-1} and are X⊗X Pauli measurement circuits when the last index iⱼ₍ₖ₎ is less than or equal to 2^{k-1}.

6. The method of preparation of quantum polar code states according to claim 5, wherein for a last recursion level, k=n, a corresponding index iⱼ₍ₙ₎=i, where i∈ [symbol] ={1, . . . ,N} is a selected information index used to encode quantum information, and for k<n, a value of iⱼ₍ₖ₎∈{1, . . . ,K=2^{k}} is determined from that of iⱼ₍ₖ₊₁₎∈{1, . . . ,2K=2^{k+1}}, such that if iⱼ₍ₖ₊₁₎>K, then iⱼ₍ₖ₎=iⱼ₍ₖ₊₁₎−K and otherwise, iⱼ₍ₖ₎=iⱼ₍ₖ₊₁₎.

7. The method of preparation of quantum polar code states according to claim 5, wherein for any level of recursion k, the quantum polar code [symbol] is associated to frozen states [symbol] = [symbol] and [symbol] := [symbol] when the Pauli Z⊗Z measurement circuits were applied on the corresponding qubits at the recursive level k−1, and to frozen states [symbol] , and [symbol] = [symbol] when the Pauli X⊗X measurement circuits were applied on corresponding qubits of the precedent recursive level k−1, where u′=u₁⊕u₂, v′=v₁⊕v₂, u₁,u₂∈{0, 1}ⁱ^{_{j(k−1)}}, v₁,
$${v}_{2} ∈ {\{ 0 , 1 \}}^{\frac{K}{2} - {i}_{j ( k - 1 )}} ,$$
with iⱼ₍ₖ₋₁₎=iⱼ₍ₖ₎−2^{k-1}, for Pauli Z⊗Z measurements, and with iⱼ₍ₖ₋₁₎=iⱼ₍ₖ₎, for Pauli X⊗X measurements, where the two equivalent polar code states
$$\vert {q}_{{2}^{k - 1}}^{1} {( k - 1 )}_{} and \vert {q}_{{2}^{k - 1}}^{2} {( k - 1 )}_{}$$
from the precedent recursive level k−1, on which the Pauli Z⊗Z or Pauli X⊗X measurement circuits were applied, were associated with frozen states [symbol] , [symbol] and [symbol] , [symbol] , respectively, and where vectors x and z are estimated on a basis of a measurement outcome m of corresponding Pauli measurement circuits and corresponding polar transform
$${P}_{\frac{K}{2}} or {P}_{\frac{K}{2}}^{⊤} ,$$
using x=P_{K/2} (m)|xⱼ₍ₖ₋₁₎ when the Pauli Z⊗Z measurement circuits were applied on the corresponding qubits at the precedent recursive level k−1, and
$$𝓏 = {P}_{K / 2}^{⊤} ( m ) {\vert}_{{𝓏}_{j ( k - 1 )}}$$
when the Pauli X⊗X measurement circuits were applied on the corresponding qubits of the precedent recursive level k−1.

8. The method of preparation of quantum polar code states according to claim 7, wherein the method of preparation is fault tolerant according to:
when the Pauli Z⊗Z measurement circuits were applied on the corresponding qubits at the recursive level k−1, if [symbol] , then a vector x is estimated using [symbol] , or otherwise it is discarded and the procedure is restarted by taking fresh polar code states of length K/2, and
when the Pauli X⊗X measurement circuits were applied on the corresponding qubits at the recursive level k−1, if
$${P}_{K / 2}^{⊤} ( m ) {\vert}_{{𝓍}_{j ( k - 1 )}} = {v}^{′} ,$$
then a vector z is estimated using
$$𝓏 = {P}_{K / 2}^{⊤} ( m ) {\vert}_{{𝓏}_{j ( k - 1 )}} ,$$
or otherwise the estimation is discarded and is restarted by taking fresh polar code states of length K/2.

9. The method of preparation of quantum polar code states according to claim 8, wherein the fault tolerant preparation of quantum polar code states is represented by the estimation of vectors x and z wherein, [symbol] x=( [symbol] , [symbol] with respect to sets
$${𝓍}_{j ( k - 1 )} = \{ {i}_{j ( k - 1 )} + 1 , … , \frac{K}{2} \} ,$$ [symbol]
:={iⱼ₍ₖ₋₁₎+1, . . . , i″}⊆ [symbol] ₍ₖ₋₁₎ and
$${𝓍}_{r}^{″} := {𝓍}_{j ( k - 1 ) ∖ 𝓍}^{″} , with {i}_{j ( k - 1 )} \leq {i}^{″} \leq \frac{K}{2} ,$$
and where
$$𝓍 {\vert}_{{𝓍}_{r}^{″}} = {P}_{K / 2} ( m ) {\vert}_{{𝓍}_{r}^{″}} and 𝓍 {\vert}_{{𝓍}^{″}} = arg {min}_{a {\vert}_{{𝓍}^{″}}} wt ( m ⊕ {P}_{K / 2} ( {u}^{′} , a {\vert}_{{𝓍}^{″}} , 𝓍 {\vert}_{{𝓍}_{r}^{″}} ) ,$$
and wherein,
$$𝓏 = ( 𝓏 {\vert}_{{𝓏}_{r}^{″}} , 𝓏 {\vert}_{{𝓏}^{″}} ) ,$$
with respect to the sets [symbol] ⱼ₍ₖ₋₁₎={1, . . . ,iⱼ₍ₖ₋₁₎}, [symbol] :={i″, . . . ,iⱼ₍ₖ₋₁₎}⊆ [symbol] ⱼ₍ₖ₋₁₎, and
$${𝓏}_{r}^{″} := {𝓏}_{j ( k - 1 )} \backslash {𝓏}^{″} ,$$
with 1≤i″≤iⱼ₍ₖ₋₁₎+1, and where
$$𝓏 {\vert}_{{𝓏}_{r}^{″}} = {P}_{K / 2}^{⊤} ( m ) {\vert}_{{𝓏}_{r}^{″}} and 𝓏 {\vert}_{{𝓏}^{″}} = arg {min}_{b {\vert}_{{𝓏}^{″}}} wt ( m ⊕ {P}_{K / 2} ( 𝓏 {\vert}_{{𝓏}_{r}^{″}} , b {\vert}_{{z}^{″}} , v ) ) .$$

10. The method of preparation of quantum polar code states according to claim 9, wherein
when [symbol] is not unique, [symbol] is discarded and the procedure is restarted by taking fresh polar code states of length K/2, and
when [symbol] is not unique, [symbol] is discarded and the procedure is restarted by taking fresh polar code states of length K/2.

11. A quantum computing system materializing qubits, quantum gates and quantum circuits, for preparation of quantum polar code states, comprising:
a set of single-qubit Pauli measurement circuits configured to prepare an initial quantum system [symbol] ={1, . . . ,N}, of N=2ⁿ single-qubit states associated to an initial quantum base, and
a set of two-qubit Pauli measurement circuits configured to recursively prepare a quantum polar code [symbol] of codelength N=2ⁿ, wherein
at each recursive level k, where k=1 to n, a set of 2ⁿ/2^{k} quantum polar code states {|q_(2\hat{ }k>_( [symbol] _j(k)),j(k)=1 to (2\hat{ }n)/2\hat{ }k} of codelengths 2^{k}, referenced by corresponding sets [symbol] ⱼ₍ₖ₎ of indices comprising first and second sets of frozen indices [symbol] ⱼ₍ₖ₎={1ⱼ, . . . , iⱼ₍ₖ₎} and
$${𝓍}_{j ( k )} = \{ ( i + 1 ) {j ( k )}_{} , … , {2}_{j ( k )}^{k} \}$$
is prepared, each quantum polar code state [symbol] being prepared by application of two-qubit Pauli measurement P⊗P circuits on two equivalent polar code states
$$\vert {q}_{{2}^{k - 1}}^{1} {( k - 1 )}_{} and \vert {q}_{{2}^{k - 1}}^{2} {( k - 1 )}_{}$$
belonging to an output of the antecedent recursive level k−1 and referenced by two corresponding sets of indices [symbol] ₍ₖ₋₁₎ and [symbol] ₍ₖ₋₁₎ each of which comprises first and second sets of frozen indices [symbol] ⱼ₍ₖ₋₁₎ and [symbol] ⱼ₍ₖ₋₁₎ corresponding to first and second quantum bases respectively, an antecedent of the first recursive level k=1 being the initial quantum system of single-qubit states.

12. The computing system comprising a classical computing system, a classical-quantum interface, and a quantum computing system according to claim 11, wherein the quantum computing system is coupled to the classical computing system via the classical-quantum interface.

13. The computing system according to claim 12, wherein the classical computing system comprises a syndrome extractor and a classical decoder, the syndrome extractor being configured to extract a syndrome out of quantum measurements implemented by the quantum computing system, and the classical decoder being configured to decode the quantum polar code by implementing successive cancelation decoding.
